(19) United States
(12) Patent Application Publication
(10) Pub. No.: US 2013/0227434 A1
(43) Pub. Date: Aug. 29, 2013

(54) Audio/Text Question Submission and Control in a Produced Online Event

(71) Applicant: American Teleconferencing Services, Ltd., (US)

(72) Inventors: Boland T. Jones, Atlanta, GA (US); David Michael Guthrie, Norcross, GA (US); Nicole C. Santoro, Decatur, GA (US)

(73) Assignee: American Teleconferencing Services, Ltd., Atlanta, GA (US)

(21) Appl. No.: 13/797,388

(22) Filed: Mar. 12, 2013

Related U.S. Application Data
(63) Continuation-in-part of application No. 13/822,379.
Application No. 13/822,379 is a continuation-in-part of application No. 12/789,993, filed on May 28, 2010.
Application No. 12/789,993 is a continuation of application No. PCT/US10/33084, filed on Apr. 30, 2010.

(51) Int. Cl. G06F 3/16

(52) U.S. Cl. CPC G06F 3/167
USPC 715/753

(57) ABSTRACT

Various embodiments of systems, methods, and computer programs are disclosed for managing question submissions in an online event produced by an event producer. One embodiment is a method comprising: a conferencing system establishing an audio conference between one or more speakers and a plurality of listen-only viewers; presenting an event production user interface to an event producer and a viewer user interface to the listen-only viewers, the event production user interface configured to enable the event producer to control the viewer user interface during the online event; receiving, via the viewer user interface, a text question submitted by one of the listen-only viewers for presentation to one or more speakers; and the event producer selecting the text question, via the event production user interface, for live audio presentation by the listen-only viewer via the audio conference.

### CROSS-REFERENCE TO RELATED APPLICATIONS

This application is a continuation-in-part patent application of and claims the benefit of the priority of the following co-pending applications: U.S. patent application Ser. No. 13/822,379, entitled “Event Management/Production for an Online Event” and filed on Mar. 12, 2013 (Attorney Docket No. 16003.1235U1), which is a U.S. National Stage Application under 35 U.S.C. 371 of International Patent Application Serial No. PCT/US11/58459, entitled “Event Management/Production for an Online Event” and filed Oct. 28, 2011 (Attorney Docket No. 16003.1235P1); and U.S. patent application Ser. No. 12/789,993, entitled “Systems, Methods, and Computer Programs for Providing a Conference User Interface” and filed May 28, 2010 (Attorney Docket No. 16003.1206U1), which is a continuation filed under 35 U.S.C. 111(a) of International Patent Application Serial No. PCT/US2010/33084, entitled “Systems, Methods, and Computer Programs for Providing a Conference User Interface” and filed Apr. 30, 2010 (Attorney Docket No. 16003.1206P1). Each of the above-referenced applications is hereby incorporated by reference in its entirety.

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for managing question submissions in an online event produced by an event producer. One embodiment is a method comprising: a conferencing system establishing an audio conference between one or more speakers and a plurality of listen-only viewers; presenting an event production user interface to an event producer and a viewer user interface to the listen-only viewers, the event production user interface configured to enable the event producer to control the viewer user interface during the online event; receiving, via the viewer user interface, a text question submitted by one of the listen-only viewers for presentation to one or more speakers; and the event producer selecting the text question, via the event production user interface, for live audio presentation by the listen-only viewer via the audio conference.

Another embodiment comprises a computer program embodied in a computer readable medium and executable by a processor for managing question submissions in an online event produced by an event producer. The computer program comprises logic configured to: establish an audio conference between one or more speakers and a plurality of listen-only viewers; present an event production user interface to an event producer and a viewer user interface to the listen-only viewers, the event production user interface configured to enable the event producer to control the viewer user interface during the online event; receive, via the viewer user interface, a text question submitted by one of the listen-only viewers for presentation to one or more speakers; and select the text question, via the event production user interface, for live audio presentation by the listen-only viewer via the audio conference.

A further embodiment comprises a computer system comprising a conferencing system and a server. The conferencing system establishes an audio conference between a plurality of listen-only viewers, an event producer, and one or more speakers, each operating a corresponding computing device connected via a communication network. The server is configured to communicate with the conferencing system and the computing devices. The server comprises one or more processors and an event management/production module, which is stored in memory and executed by the processors. The event management/production module comprises: logic configured to present an event production user interface to an event producer and a viewer user interface to the listen-only viewers, the event production user interface configured to enable the event producer to control the viewer user interface during the online event; logic configured to receive, via the viewer user interface, a text question submitted by one of the listen-only viewers for presentation to one or more speakers; and logic configured to display the text question in the event production user interface and receive a selection of the text question for live audio presentation by the listen-only viewer via the audio conference.

### BRIEF DESCRIPTION OF THE DRAWINGS

FIG. 1 is a block diagram illustrating an embodiment of a computer system for managing and/or producing an online event comprising one or more speakers and a plurality of viewers.

FIG. 2 is a combined functional/block diagram illustrating the general architecture, operation, and/or functionality of an embodiment of the event management/production module(s) of FIG. 1.

FIG. 3 is a data diagram illustrating an embodiment of a data structure for defining, managing, and controlling the participant roles in the online event.

FIG. 4 is a flowchart illustrating the architecture, operation, and/or functionality of an embodiment of the event management/production module(s) of FIG. 1.

FIG. 5 is a user interface screen shot illustrating an embodiment of the event production user interface of FIGS. 1 & 2 for displaying an events dashboard.

FIG. 6 illustrates a first configuration step for scheduling a new online event via the event production user interface of FIG. 5.

FIG. 7 illustrates a second configuration step for scheduling a new online event via the event production user interface of FIG. 5.

FIG. 8 illustrates a third configuration step for scheduling a new online event via the event production user interface of FIG. 5.

FIG. 9 is a user interface screen shot illustrating another embodiment of an event production user interface for enabling an event producer to selectively control views associated with the viewer user interface.

FIG. 10 is a flowchart illustrating an embodiment of the event management/production module(s) of FIGS. 1 & 2 for selectively controlling views associated with the viewer user interface via the event production user interface.

FIG. 11 is a user interface screen shot illustrating an embodiment of the viewer user interface in which the event producer has selected an “all speakers” view.

FIG. 12 illustrates an embodiment of a chat moderation control implemented via the event production user interface.

FIG. 13 is a user interface screen shot illustrating an embodiment of the event production user interface for enabling the event producer to selectively define and share media files to be presented to the viewer user interface during the online event.

FIG. 14 illustrates an embodiment of the viewer user interface after the event producer has shared a media file.

FIG. 15 illustrates an embodiment of the media sharing control provided via the event production user interface.

FIG. 16 is a flowchart illustrating an embodiment of the event management/production module(s) of FIGS. 1 & 2 for implementing the media sharing control of FIG. 15.

FIG. 17 illustrates an embodiment of a Q&A management control provided via the event production user interface.

FIG. 18 illustrates an embodiment of the viewer user interface after the event producer has selected a question submitted by one of the viewers.

FIG. 19 is a flowchart illustrating an embodiment of the event management/production module(s) of FIGS. 1 & 2 for implementing the Q&A management control of FIG. 17.

FIG. 20 is a user screen shot illustrating an embodiment of a speaker user interface provided to speakers participating in the online event.

FIG. 21 is an event registration screen displayed in a viewer user interface.

FIG. 22 illustrates an exemplary confirmation email after a viewer has registered for an online event.

FIG. 23 illustrates an embodiment of a “waiting room” functionality provided via the viewer user interface before an online event begins.

FIGS. 24a & 24b illustrate another embodiment of a method for managing text/audio question submission in an online event via the system of FIG. 1.

FIG. 25 is a screen shot illustrating another embodiment of the viewer user interface with a question submission component for selectively controlling text/audio question submission in the online event.

FIG. 26 is a screen shot illustrating another embodiment of the event production user interface with a Q&A component for selectively controlling text/audio question submission in the online event.

FIG. 27 illustrates the event production user interface of FIG. 26 after the event producer has selected the “via audio” button.

FIG. 28 illustrates an embodiment of the viewer user interface associated with the question submitter comprising a question submission prompt.

FIG. 29 illustrates an embodiment of the viewer user interface displayed to the other listen-only viewers while the question submitter is configuring a two-way audio connection.

FIG. 30 illustrates an embodiment of the event production user interface while the question submitter is configuring the two-way audio connection.

FIG. 31 illustrates the data structure of FIG. 3 in a first state with the question submitter having a “viewer” role.

FIG. 32 illustrates the data structure of FIG. 31 after the question submitter's role has been changed to a “live question” role and a two-way audio connection has been established.

FIG. 33 illustrates an embodiment of the viewer user interface during the live audio presentation of the submitted question.

FIG. 34 illustrates an embodiment of the event production user interface during the live audio presentation of the submitted question.

FIG. 35 illustrates the event production user interface of FIG. 34 after the event producer has muted the question submitter.

### DETAILED DESCRIPTION

Various embodiments of systems, methods, and computer programs are disclosed for managing and/or producing an online conference or event. The online event may be used for conferences, meetings, groupings, or other types gatherings (collectively, an online “conference” or “event”). The online conference may be organized, hosted, promoted, produced, or presented by any business, group, individual, or other content provider for any desirable purpose or target audience (e.g., promotional events, online seminars, entertainment broadcasts, product launches, corporate events, etc.).

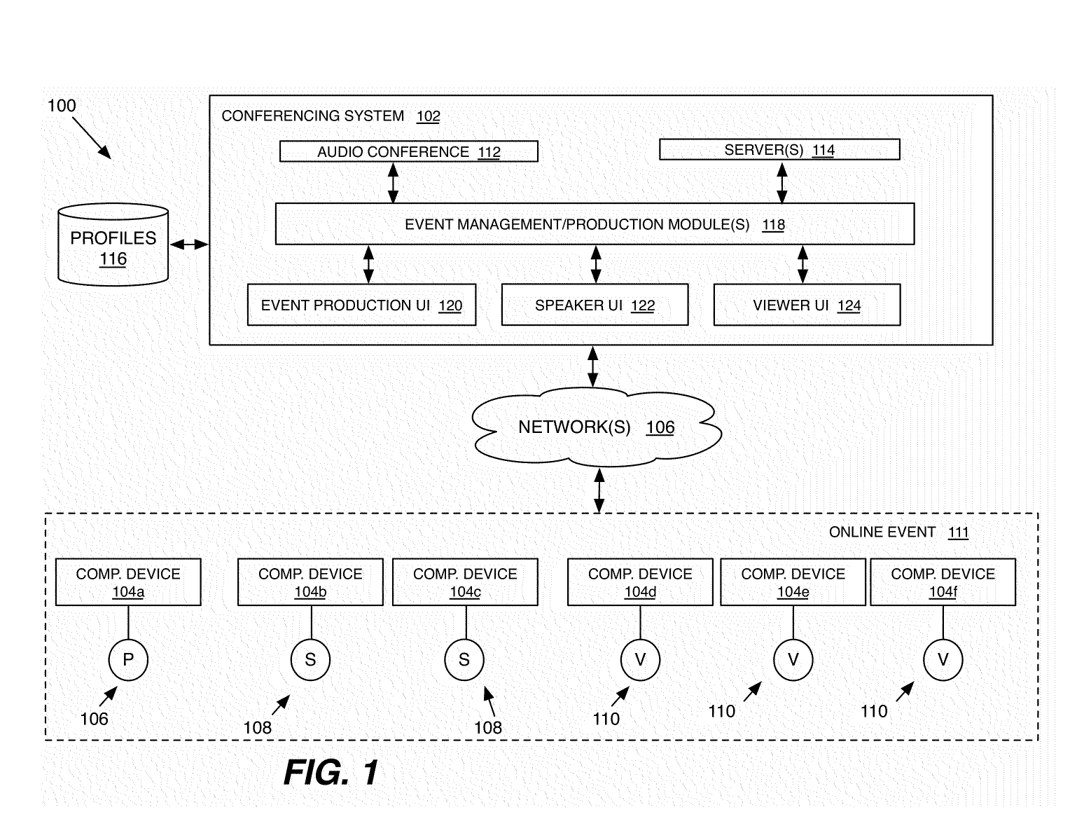

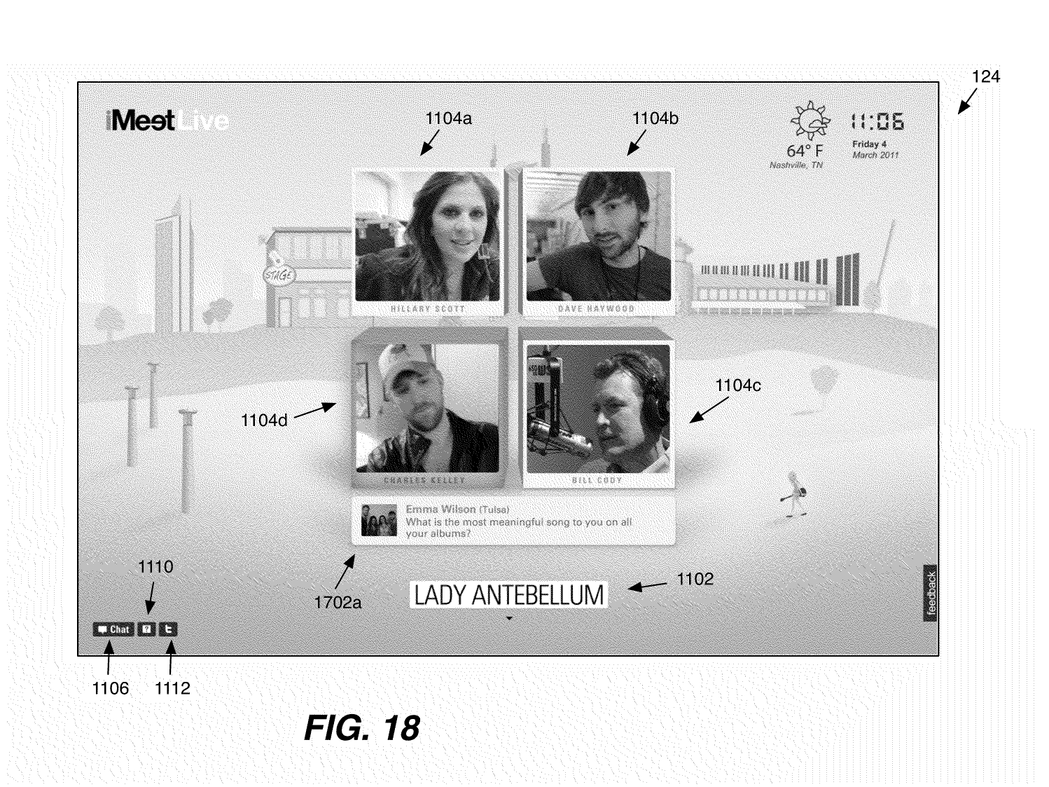

As described below in more detail with reference to FIGS. 1-23, the online event is provided by a system that establishes an audio conference between one or more speakers and a target audience. The target audience (referred to as “viewers”) may experience the audio conference in a listen-only mode (“listen-only viewers”). The system providing the audio conference (a “conferencing” or “conference” system) also presents various role-specific conference user interfaces to the participants during the online event. A viewer user interface comprises the main user interface for presenting the audio conference and the online event to the viewers. A speaker user interface may be presented to the speakers, which may mirror the viewer user interface in terms of content but with optional functionality or alternative content not presented to the viewers. An event production user interface comprises a specially-configured user interface for enabling an event producer to selectively control various aspects of the viewer user interface and/or the speaker user interface. It should be appreciated that the control mechanisms generally comprise tools for enabling the event producer to customize or configure—during the online event—the manner in which the viewers and the speakers experience the online event. In exemplary embodiments, the event production user interface may be configured to enable the event producer to, for example, specify an active speaker to be displayed in the viewer user interface, select one or more presentation schemes or views for the viewer user interface, select and introduce media (e.g., audio, video, documents, presentations, graphics, etc.) for presentation in the viewer user interface, moderate public and/or private chats between the viewers and/or the speakers, or view questions submitted by the viewers and select which ones to present in the viewer user interface.

The conferencing system and the conference user interfaces may be generally configured in the manner described in the above-referenced parent application. The conference user interfaces may be configured to provide any desirable content and/or functionality and may support various user interface and/or conferencing features.

FIG. 1 illustrates an embodiment of a computer system 100 for providing an online event 111 that may be managed and/or produced by an event producer. The computer system 100 comprises a conferencing system 102 and a plurality of computing devices 104 connected via one or more communication networks 106. The network(s) 106 may support wired and/or wireless communication via any suitable protocols, including, for example, the Internet, the Public Switched Telephone Network (PSTN), cellular or mobile network(s), local area network(s), wide area network(s), or any other suitable communication infrastructure. The computing devices 104 may be associated with corresponding participants (an event producer 106, one or more presenters or speakers 108, and viewers 110) in an online event 111 (including an audio conference 112).

The computing devices 104 may comprise any desirable computing device, which is configured to communicate with the conferencing system 102 and an associated server(s) 114 via the networks 106. The computer device 104 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 102 and/or the server(s) 114 via one or more networks 106. The computing device 104 may include client software (e.g., a browser, plug-in, or other functionality) configured to facilitate communication with the conferencing system 102 and the server 114. It should be appreciated that the hardware, software, and any other performance specifications of the computing device 104 are not critical and may be configured according to the particular context in which the device is to be used.

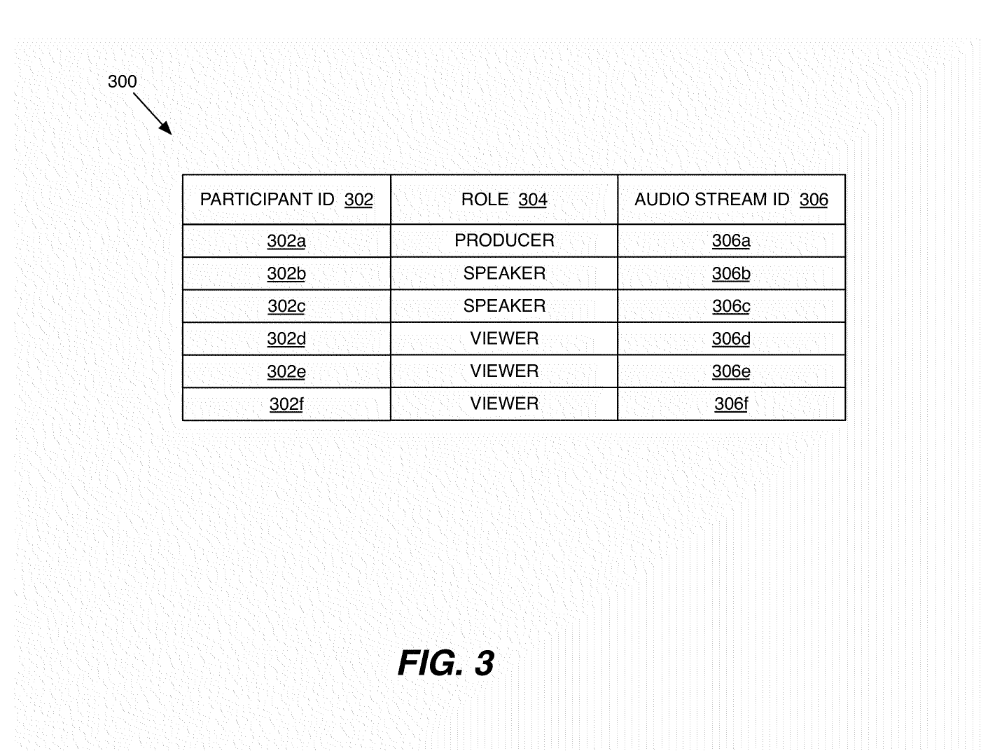

In the embodiment of FIG. 1, the conferencing system 102 generally comprises a communication system for establishing an online event 111 and/or the audio conference 112 between the computing devices 104. The conferencing system 102 may support audio via a voice network and/or a data network. In one of a number of possible embodiments, the conferencing system 102 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 102 may support various alternative platforms, technologies, protocols, standards, features, etc. Regardless of the communication infrastructure, the conferencing system 102 may be configured to establish an audio connection with the computing devices 104, although in some embodiments the audio portion may be removed. As illustrated in FIG. 3, the conferencing system 102 and/or servers 114 may establish the audio conference 112 by combining audio streams 306a-306f associated with computing devices 104a-104f. Each computing device 104 may be logically associated with a unique participant ID 302 stored in a profiles database 116. The role of the participants may be defined with a role status 304 indicating whether the participant is a speaker 108, a viewer 110, or the event producer 106.

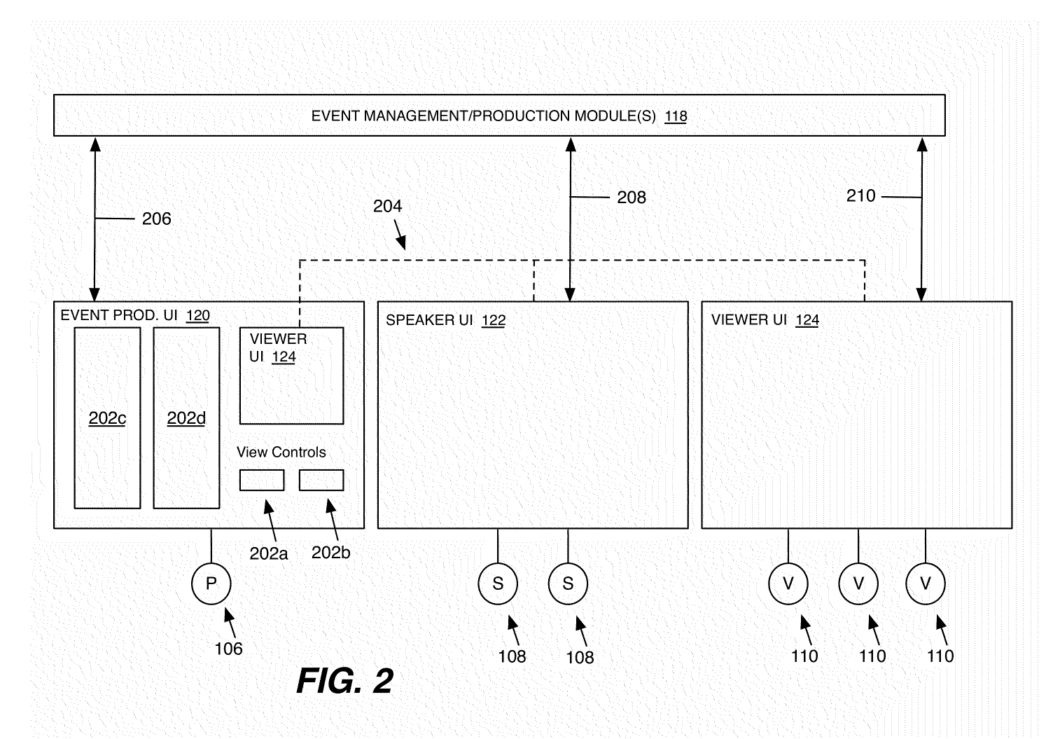

Referring again to FIG. 1, conferencing system 102 may comprise event management/production module(s) 118 configured to present an event production user interface 120, a speaker user interface 122, and a viewer user interface 124. As illustrated in FIG. 2, during the online event, the event production user interface 120 is presented to the event producer 106, the speaker user interface 122 is presented to the speakers 108, and the viewer user interface is presented to the viewers 110. Each of the user interfaces 120, 122, and 124 may be presented via a client application (e.g., a browser, one or more browser plug-ins, and/or a special-purpose client). It should be appreciated that the user interfaces 120, 122, and 124 may include logic located and/or executed at the computing devices 104, the conferencing system 102, server(s) 114, or any combination thereof, and may be presented to and displayed via a graphical user interface and an associated display (e.g., touchscreen display device or other display device).

The event management/production modules 118 (and any other associated control and presentation modules) may be embodied in memory and executed by one or more processors. It should be appreciated that any aspects of the event management/production modules 118 may be stored and/or executed by the computing devices 104, the conferencing system 102, the servers 114, or other related server(s) or web services.

Referring to FIG. 2, the event management/production module(s) 118 enable the conferencing system 102 to separately configure, manage, and control the user interfaces 120, 122, and 124, as well as provide the audio conference 112 and any other content and/or functionality to the computing devices 104. Communications with the event producer 106 may be controlled via a communication channel 206 that presents the event production user interface 120. Communications with the speakers 108 may be controlled via a communication channel 208 that presents the speaker user interface 122. Communications with the viewers 110 may be controlled via a communication channel 210.

As mentioned above, the event production user interface 120 generally comprises various tools for enabling the event producer 106 to selectively control various aspects of the viewer user interface 124 and/or the speaker user interface 122 during the online event 111. The event production user interface 120 may comprise one or more user interface components (202) for implementing various control features. In the exemplary embodiment of FIG. 2, the viewer user interface 124 and/or the speaker user interface 122 may be simultaneously displayed in the event producer user interface 120 (reference line 204) to enable the event producer 106 to see what is being displayed to the speakers 108 and/or the viewers 110 during the online event 111. It should be appreciated that the control mechanisms 202 generally comprise production tools for enabling the event producer 106 to customize the content and/or functionality presented in the speaker user interface 122 and/or the viewer user interface 124.

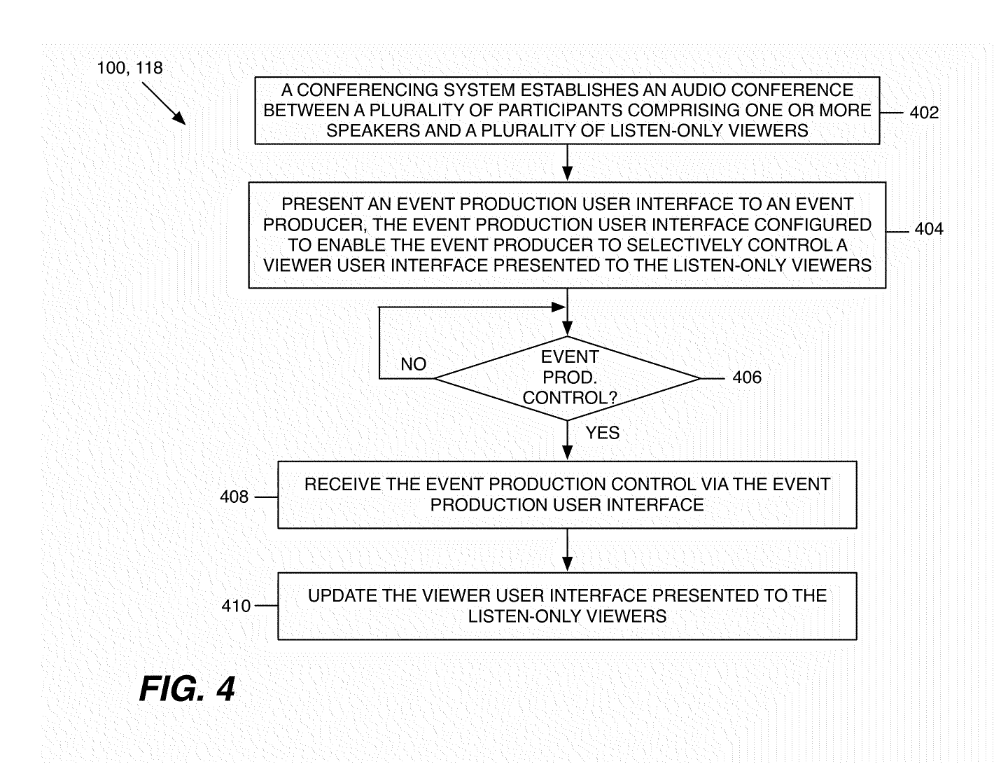

FIG. 4 is a flowchart illustrating the general architecture, operation, and/or functionality of an embodiment of the event management/production modules 118. At block 402, the conferencing system 102 establishes an audio conference 112 between one or more speakers 108, the event producer 106, and a plurality of viewers 110 accessing the conferencing system 102 via computing devices 104 connected to network(s) 106. Although not required, the viewers 110 may be added to the audio conference 112 in a listen-only mode so that they are only able to listen to the audio, while the speakers 108 are able to listen and speak. Depending on the particular purpose and context for the event, the online event 111 may host any number of event producers 106, speakers 108, and viewers 110. It should be appreciated, however, that the event production and management tools may be particularly advantageous for controlled situations in which the event is organized by a content provider and directed to a large audience of viewers 110 (e.g., hundreds or even thousands or more viewers).

At block 404, the conferencing system 102 and/or servers 114 present the event production user interface 120 to the event producer 106. As described below in more detail, the event production user interface 120 may comprise various components 202 for enabling the event producer 106 to selectively control the content and/or functionality presented in the viewer user interface 124 and speaker user interface 122. If the event producer 106 desires to produce content or configure certain functionality or applications, the applicable event production/management controls (components 202) are selected via the event production user interface 120 (decision block 406). At block 408, the event management/production modules 118 receive an event production control command initiated by the event production user interface 120. In response to the command, the event production/management modules 118 determine the particular control being requested and then update the viewer user interface 124 and/or the speaker user interface 122 with the associated content and/or functionality.

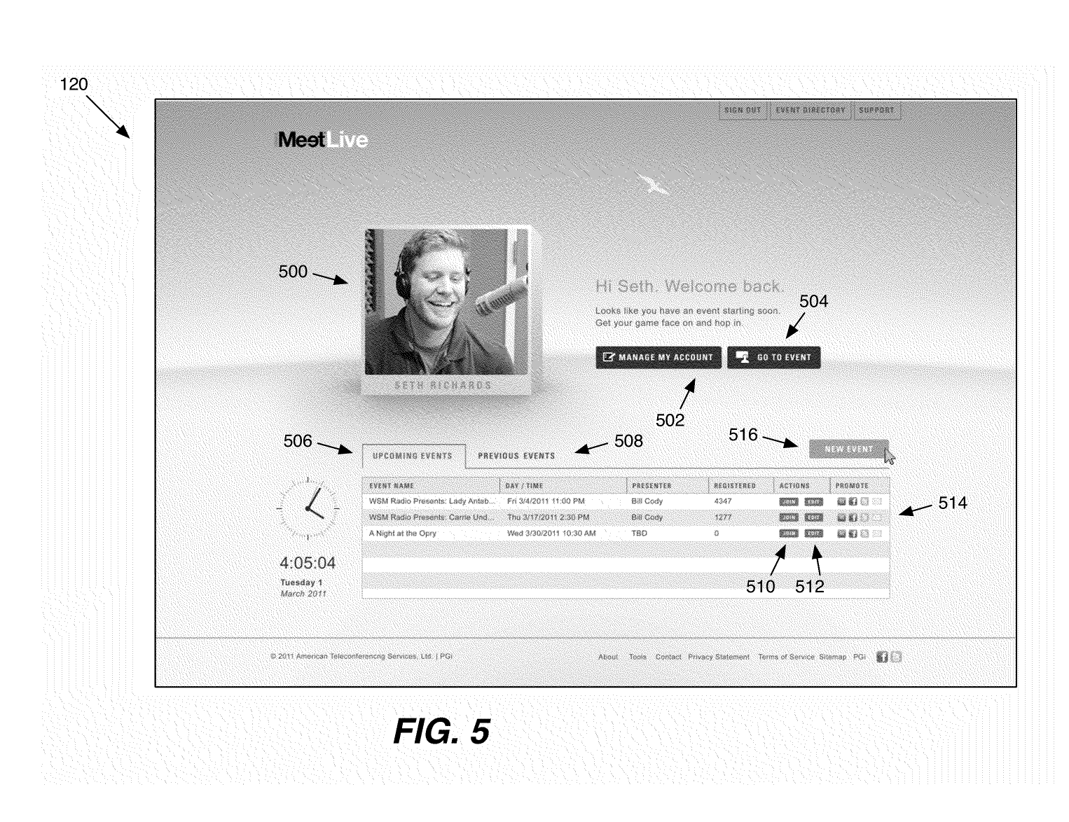

It should be appreciated that the event production/management controls may be initiated, scheduled, or performed at any applicable time before the online event 111 or during the online event 111. FIG. 5 illustrates an embodiment of the event production user interface 120 for managing upcoming events (tab 506) or previous events (tab 508), scheduling new events (component 516), starting an event (component 504), or managing an event production account (component 502). The event production account may be associated with a content provider or a third party that manages online events 110 for the content provider. FIG. 5 illustrates a list of upcoming scheduled events by event name, day/time and presenter, and may indicate the number of current viewers registered for the online event 111. The event producer 106 may join an online event 111 already scheduled by selecting an item from the list view (join button 510). Existing online events 110 may also be edited via edit button 512 or promoted via associated social networking or other web-based communication or marketing tools (buttons 514).

As described in the above-referenced parent patent application, the various user interfaces may be configured to visually identify one or more participants with unique participant objects 500 for identifying the participants. In FIG. 5, a participant object 500 is displayed identifying the event producer 106. In an embodiment, a participant object 500 (displayed in any of the user interfaces 120, 122, and 124) may comprise a graphical representation, profile information, an audio indicator, and a business card component. The graphical representation may comprise a picture, photograph, icon, avatar, etc. for identifying the corresponding participant. The graphical representation may comprise an image that is uploaded to the server 114, imported from a social networking profile, or selected and/or customized from predefined images. The graphical representation may also comprise a default image if one has not been defined by a participant.

The profile information may comprise information provided by the participant and stored in user profiles database 116 (FIG. 1). The audio indicator visually identifies when the associated participant is speaking during the audio conference 112 by monitoring the audio streams 306. The audio stream 306 may be logically associated with the corresponding audio indicator according to a participant identifier 302. During the audio conference 112 when a participant is speaking, the audio indicator may be displayed in a first visual state, such as, by graying out the audio indicator. When the participant is speaking, the audio indicator may be displayed in a second visual state, such as, by blacking out the audio indicator. It should be appreciated that any visual and/or audio distinctions may be employed to identify a speaking participant in any of the user interfaces 120, 122, and 124.

The participant objects 500 may include a user interface component for launching a business card component that, when selected, displays further information about the participant. The business card component may trigger the display of any additional participant profile or identification information. When the component is selected, the participant object 500 “flips” to the business card component, which displays additional parameters (e.g., name, title, organization, location, contact information, interests, or other biographical information). The business card component may further comprise a participant profile control, which comprises a user interface control for enabling the participants to edit their own, or another participant's, information during the online event 111. An “exit” button may be selected to “flip” the object to a default display.

In another embodiment, the interactive participant object 500 may be customized by a participant. The participant object 500 may be configured as an interactive shape (e.g., a cube) with a plurality of user-selectable display portions (e.g., two or more cube faces. The cube faces may be customized to display various types of information, including, a personal greeting, a menu listing available social networking accounts associated with the participant. As described in the above-referenced patent application, the conferencing system 102 may be configured to communicate with social networking systems via an API. During the online event 111, other participants may interact with displayed participant objects 500 and, for example, view the participant's social networking profile displayed in one of the cube faces. One or more links may also be displayed for viewing the participant's full profile, as well as sending a request to join the participant's social network. In another embodiment, a participant may also customize various aspects of the participant objects 500 during the online event 111. The participants may also resize a particular participant object 500, rearrange displayed participant objects 500, or customize their own participant object 500 directly from the participant object 500.

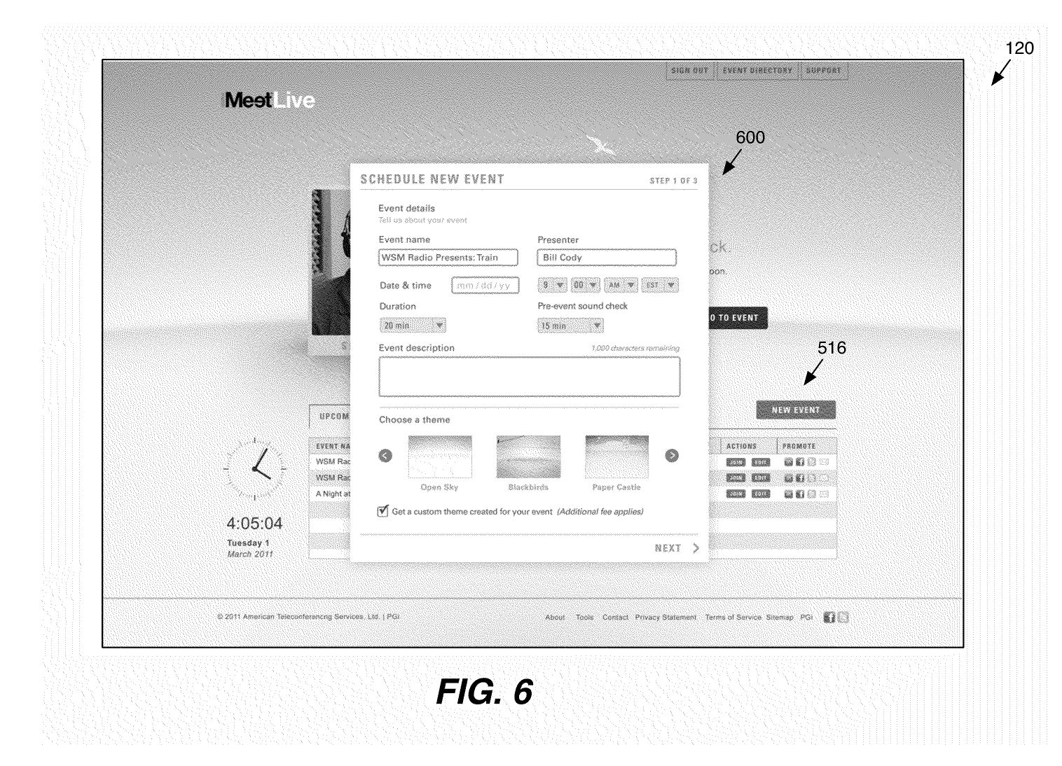

FIGS. 6-8 illustrate a series of exemplary screen shots for scheduling a new online event 111 via the event production user interface 120 (button 516). In this embodiment, the event producer 106 is taken through three steps for configuring various aspects of the online event. In step 1 (FIG. 6), the event producer is prompted to enter or configure parameters, such as, the event details, event description, event name, presenter, date/time, duration, pre-event sound check (a set time prior to beginning the online event 111), and a theme for the viewer user interface 124 or speaker user interface 122.

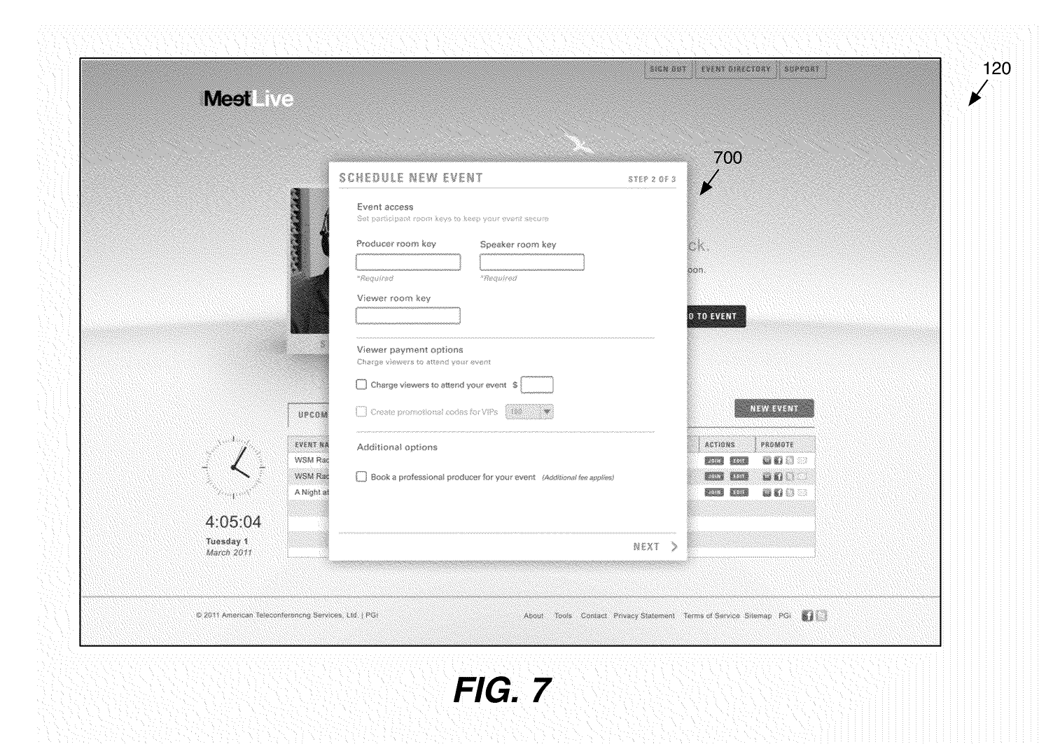

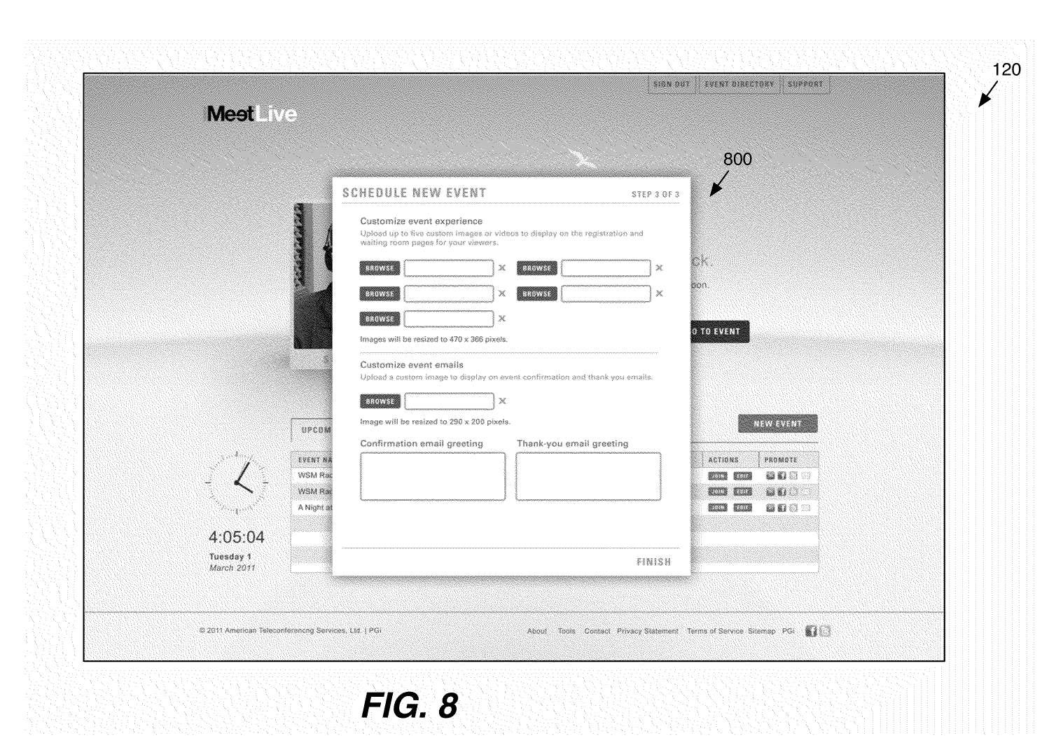

In step 2 (FIG. 7), the event producer 106 may configure security/access permissions for the online event 111 by specifying role-specific keys or passwords for the event producer 106, speakers 108, and viewers 110. The content provider may also control whether the online event 111 will be a free event, specify a charge to attend, or issue promotional codes. The content provider may also choose to hire a third party production company to manage and produce the online event 111. In step 3 (FIG. 8), the event producer 106 may customize the event experience by uploading, for example, custom images, videos, graphics, or other media to configure the viewer user interface 124 during or before the online event or, alternatively, to configure confirmation emails or other messages presented to registered viewers.

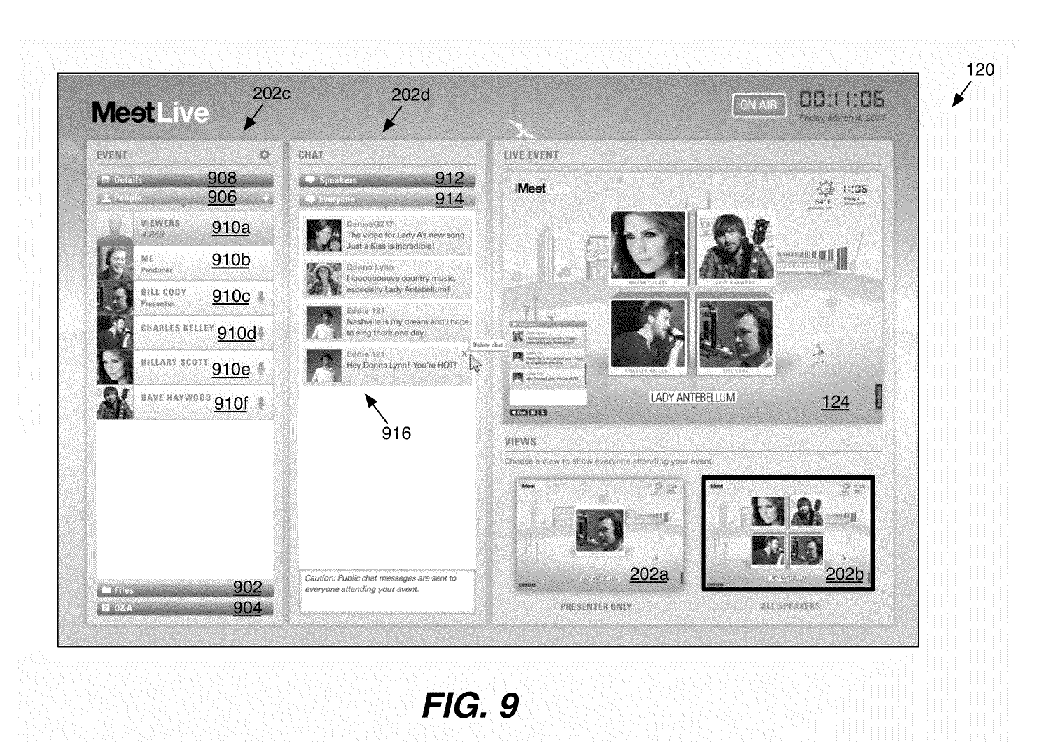

FIGS. 9-11 illustrate an embodiment of a view selection control implemented via the event production user interface 120. In general, the view selection control enables the event producer 106 to selectively control, during the online event 111, which of a plurality of predetermined views are to be displayed to the viewers 110 in the viewer user interface 124. Referring to FIG. 9, the event production user interface 120 may simultaneously display the viewer user interface 124 and the various control components 202. An event control component 202c may comprise an interactive control panel for selectively accessing details about the online event (details bar 908) and interacting with a list of participants (people bar 906). When selected, the people bar 906 may display list items 910 identifying the participants by name and role (i.e., speaker, viewer, or event producer) with an optional avatar, icon, photograph, or other visual graphics. Where a large number of viewers 110 are participant, they may be grouped into a single item 910 with an indication of the number of current viewers. As described below in more detail, the event control component 202c may further comprise a file or media sharing bar 902 and a Q&A bar 904. The file sharing bar 902 enables the event producer 106 to produce content in the viewer user interface 124 during the online event 111, and the Q&A bar 904 enables the event producer 106 to manage questions submitted by the viewers 110.

A chat control component 202d may comprise a further interactive panel for controlling, managing, and moderating online chats or other messaging applications between the speakers 108 and/or the viewers 110. A speakers bar 912 exposes messages 916 exchanged during a speaker chat, and the everyone bar 914 exposes messages 916 submitted by the viewers 110.

View selection controls 202a and 202b provide a convenient production tool for enabling the event producer to selectively change predefined views associated with the viewer user interface 124. The views may customize any desirable presentation parameters. In the embodiment illustrated in FIG. 9, the view selection control 202a enables the event producer 106 to configure the viewer user interface 124 to display only the current speaker 108 in the online event 111. The view selection control 202b enables the event producer 106 to display all speakers 108. Regardless the view, the displayed speakers 108 may be visually identified with corresponding participant objects 500, as described above.

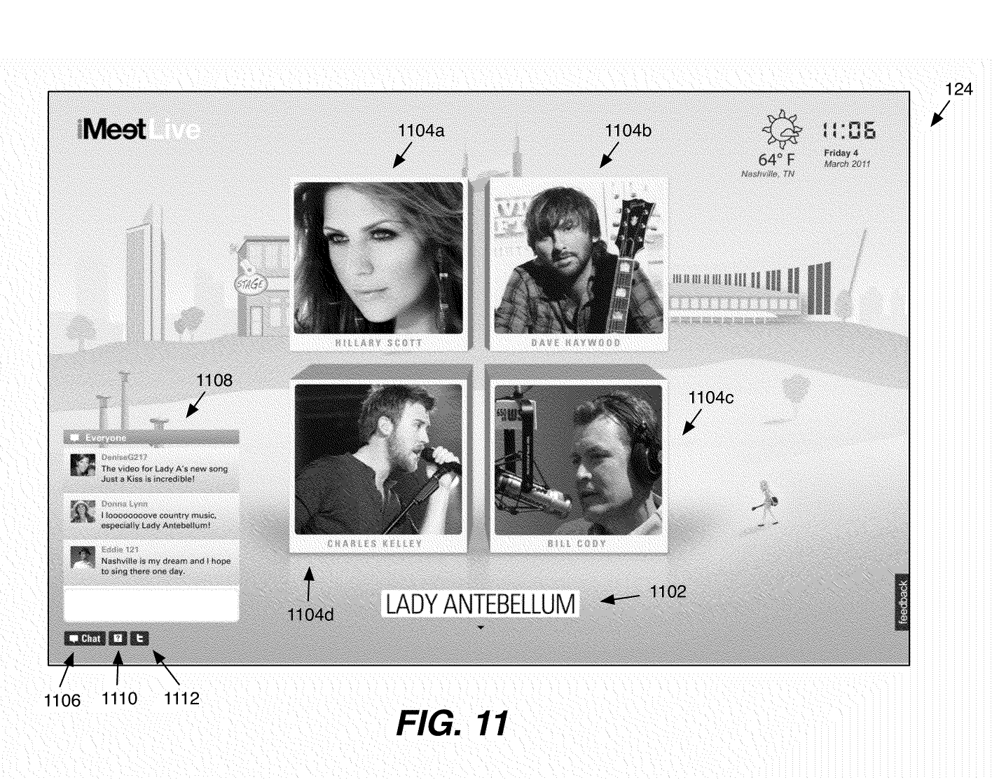

In operation, the event producer 106 may select either of the view selection controls 202a and 202b. The event management/production modules 118 determine which view is selected in the event production user interface 120 and presents the corresponding view in the view user interface 124. FIG. 9 shows that the view selection control 202b has been selected. FIG. 11 illustrates the resulting view presented in the viewer user interface 124, in which all four speakers 108 are identified with a corresponding participant object 1104a, 1104b, 1104c, and 1104d. As further illustrated in FIG. 11, the viewer user interface 124 may also display other information about the online event 111 (e.g., an event title 1102), current date/time, and other information customized to the particular viewer 110 (e.g., local weather, news, etc.). As described below in more detail, the viewer user interface 124 may also present user interface components for accessing various conferencing features, such as, for example, a viewer chat (chat component 1106), a question submission component 1110 for submitting questions to the event producer 106, and a social networking component 1112 for interacting with a social networking feed associated with the online event 111.s

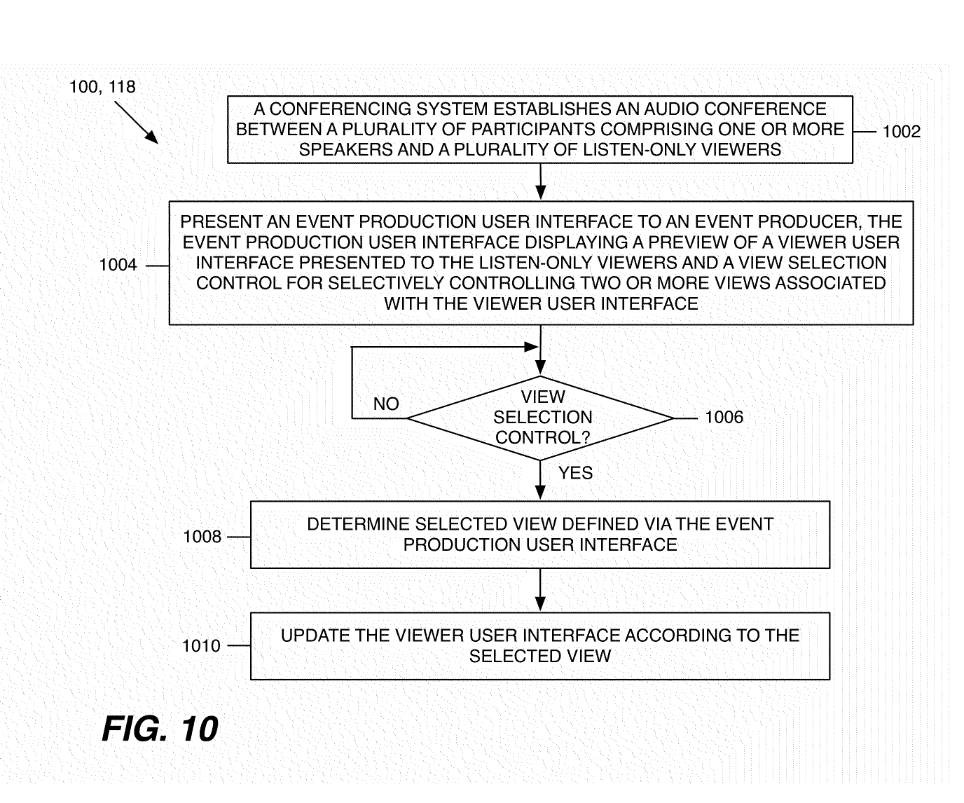

FIG. 10 illustrates the architecture, operation, and/or functionality of an embodiment of the event management/production modules 118 for implementing the view selection control. At block 1002, the conferencing system 102 establishes an audio conference 112 between one or more speakers 108, the event producer 106, and a plurality of viewers 110 accessing the conferencing system 102 via computing devices 104 connected to network(s) 106. At block 1004, the conferencing system 102 and/or servers 114 present the event production user interface 120 to the event producer 106. The event production user interface 120 may simultaneously display the viewer user interface 124 and the view selection control components 202a and 202b (FIGS. 2 & 9). At decision block 1006, the event management/production modules 118 determine whether the current view is to be changed to a new view. If the event producer 106 initiates a change to a new view or otherwise changes presentation parameters associated with the viewer user interface 124, the event management/production modules 118 determine the selected new view or presentation parameters (block 1008) and updates the viewer user interface 124 accordingly (block 1010).

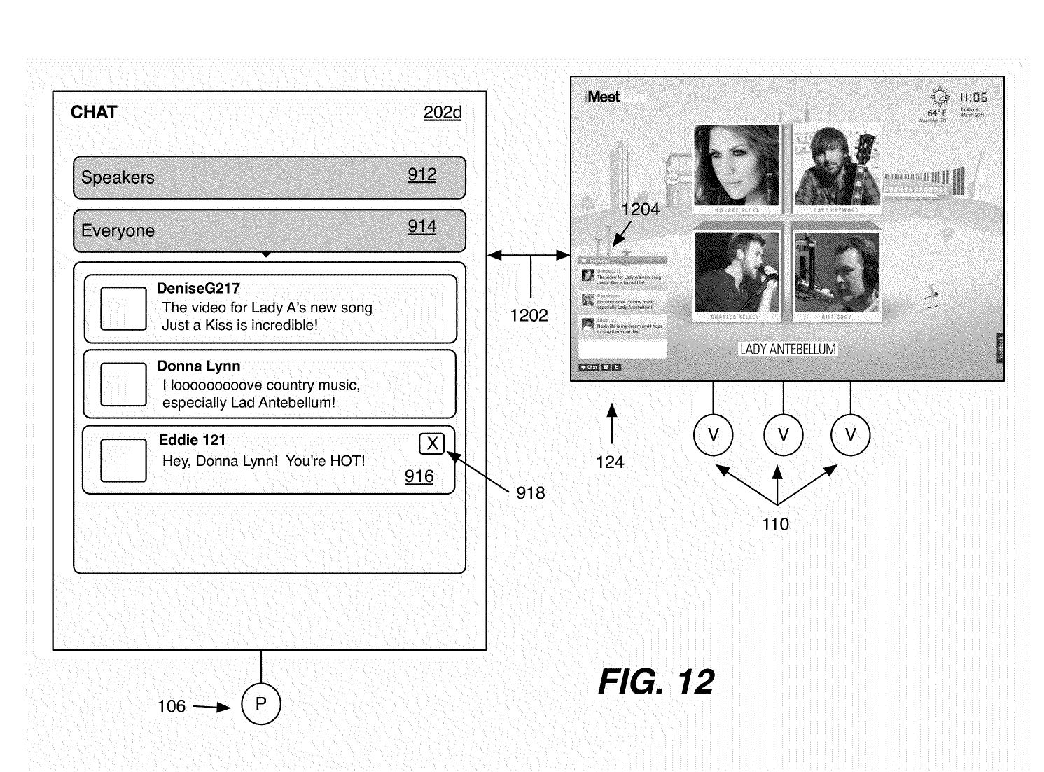

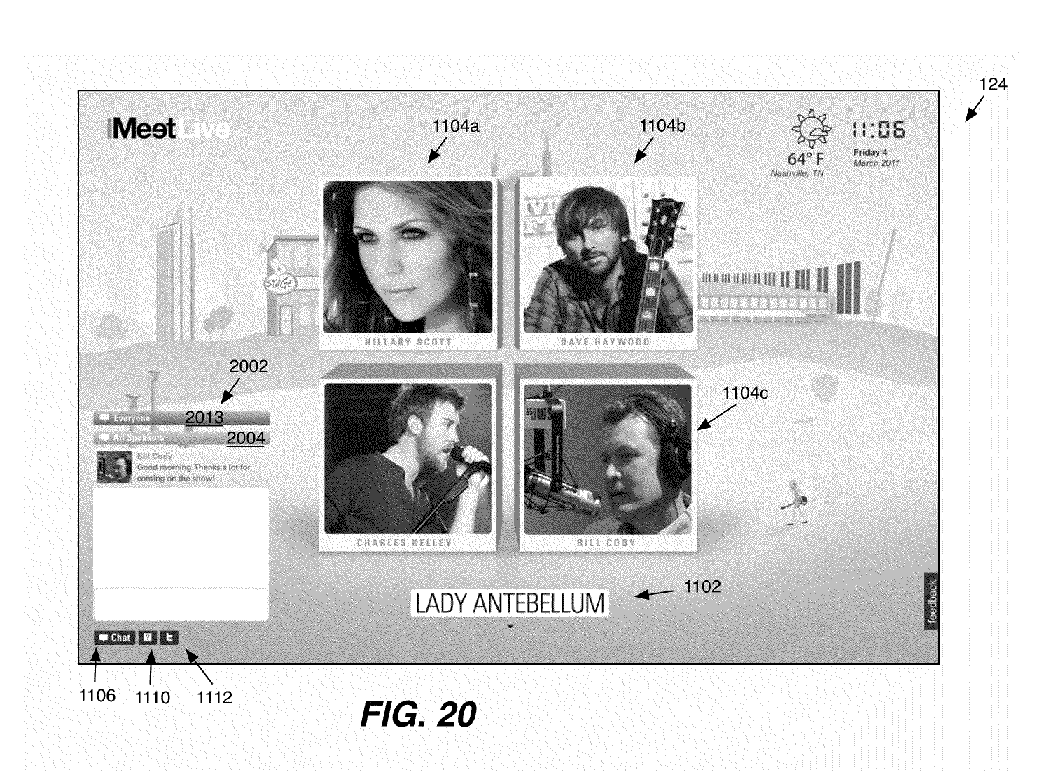

FIGS. 12 & 20 illustrate a more detailed view of the chat control component 202d and the operation of the associated features for moderating a viewer or speaker chat. FIG. 12 illustrates a viewer chat panel 1204 that may be launched from the chat component 1106. The viewer chat panel 1204 enables viewers 110 to interact with each other by submitting text or other messages via the conferencing system 102 or other systems, such as, a social networking computer system. FIG. 20 illustrates an embodiment of a speaker user interface 122 for enabling speakers 108 to exchanges messages either with each other, the viewers 110, or any combination thereof. The speaker user interface 122 may include a speaker chat panel 2002 (FIG. 20), which may be selectively displayed via a chat button 1106. The speaker chat panel 2002 may separately display a speaker chat application (speaker bar 2004) and a public chat application (everyone bar 2003). Referring again to FIG. 12, the event production user interface 120 may maintain a communication channel 1202 for receiving and displaying the messages 916 submitted by the speakers 108 (speakers bar 912) and the viewers 110 (everyone bar 914). The event producer 106 may moderate either chat by, for example, deleting inappropriate messages 916 via, for example, a delete button 918.

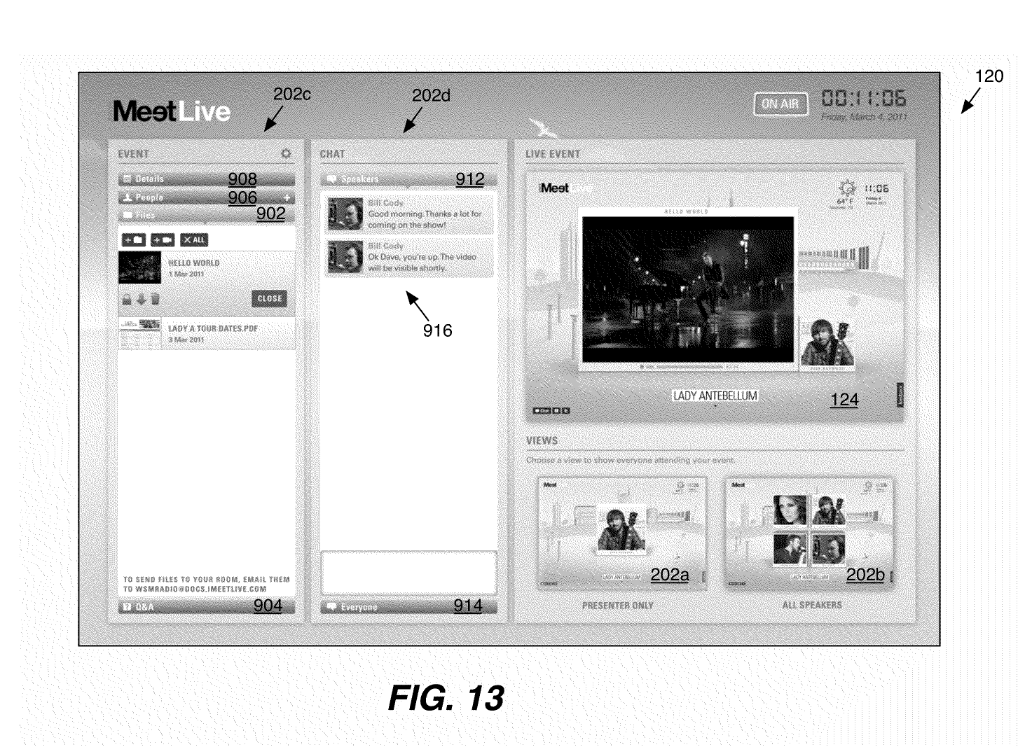

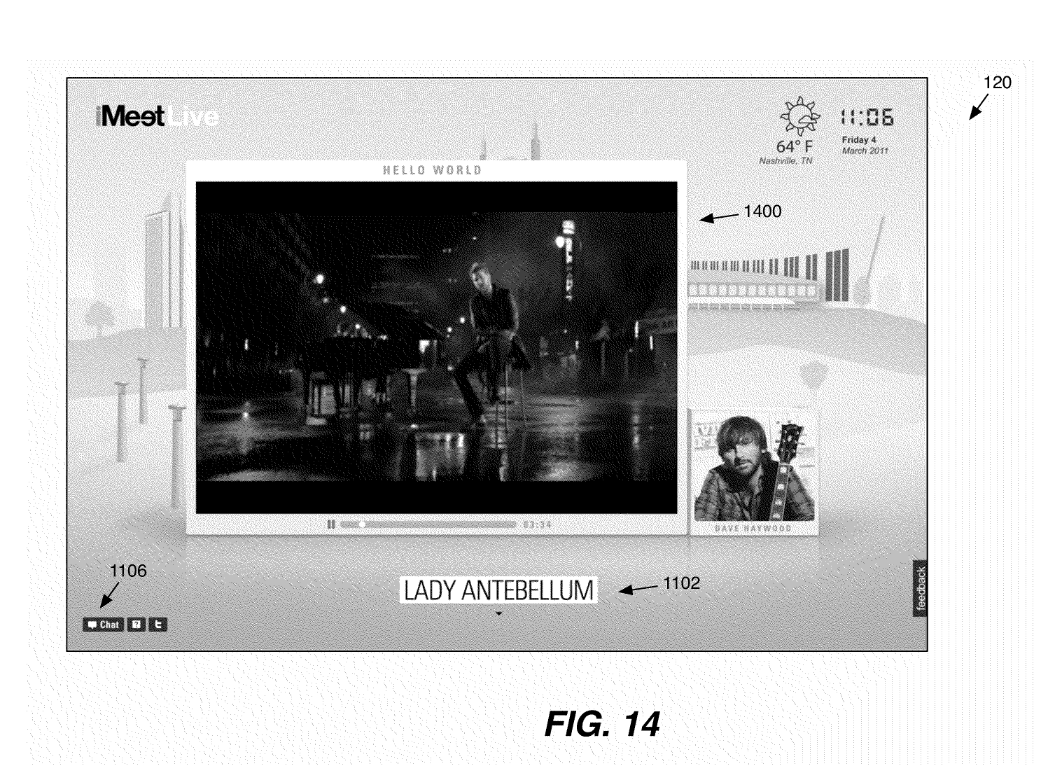

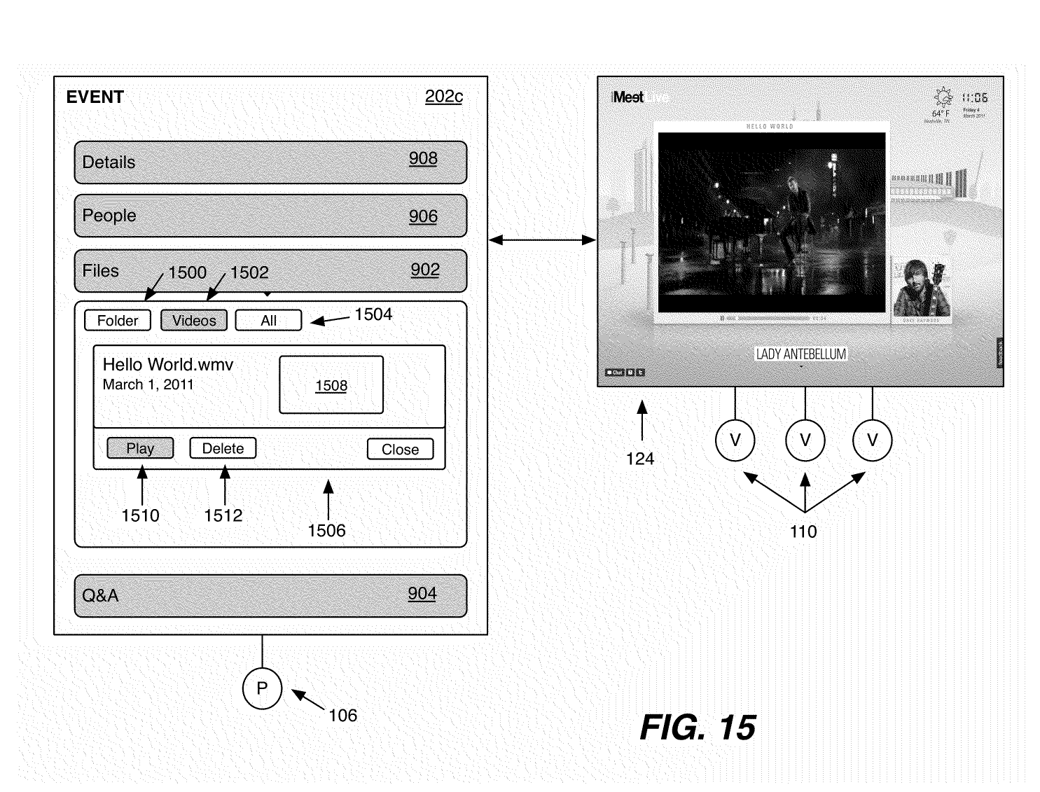

FIGS. 13-16 illustrate an embodiment of a file or media sharing control implemented via the event production user interface 120. FIGS. 13 & 15 illustrate the file sharing bar 902 expanded to present control functions for enabling the event producer 106 to specify content to be presented in the viewer user interface 124 during the online event 111. As best illustrated in FIG. 15, the event producer 106 may search or browse for media stored in a local or remote folder (folder button 1500) or, alternatively, view all available media files (all button 1504) or according to type (e.g., video button 1502). In FIG. 15, the video button 1502 has been selected to display a media file 1506 available for presentation in the viewer user interface 124. It should be appreciated that the media file 1506 may comprise any type of media, such as, text, graphics, video, or audio in any desirable format (e.g., documents, presentations, videos, images, etc.). The media file 1506 may be displayed with a corresponding thumbnail image 1508 along with a play button 1510 and a delete button 1512. To produce the media to the viewer user interface 124, the event producer 106 may select the play button 1510. In response to selection of the play button 1510, the applicable media file 1506 may be automatically presented to the viewer user interface 124 (FIGS. 14 & 15).

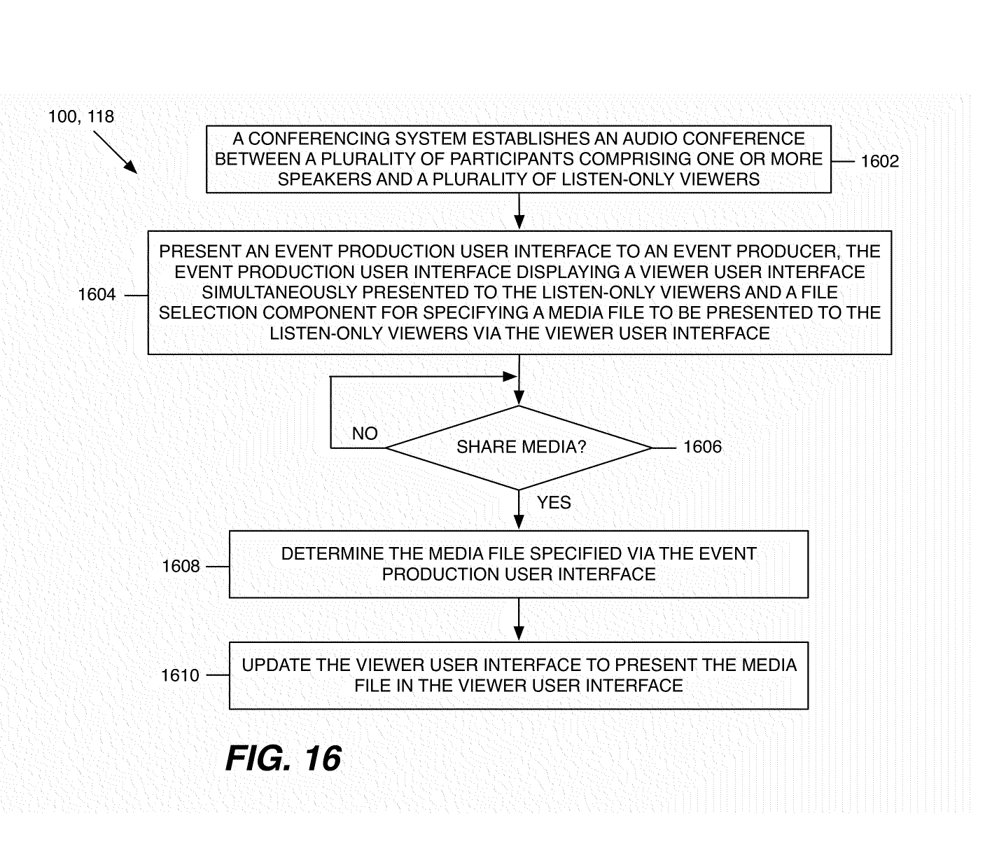

FIG. 16 illustrates the architecture, operation, and/or functionality of an embodiment of the event management/production modules 118 for implementing the media sharing control. At block 1602, the conferencing system 102 establishes an audio conference 112 between one or more speakers 108, the event producer 106, and a plurality of viewers 110 accessing the conferencing system 102 via computing devices 104 connected to network(s) 106. At block 1604, the conferencing system 102 and/or servers 114 present the event production user interface 120 to the event producer 106 and the viewer user interface 124 and the speaker user interface 122 to the viewers 110 and speakers 108, respectively. The event production user interface 120 may simultaneously display the viewer user interface 124 and a file sharing bar 902. At decision block 1606 and block 1608, the event management/production modules 118 determines the media file 1506 identified by the event producer 106 via the event production user interface 120. At block 1610, in response to the command initiated by the event producer 106, the event management/production modules 118 present the media file 1506 in the viewer user interface 124.

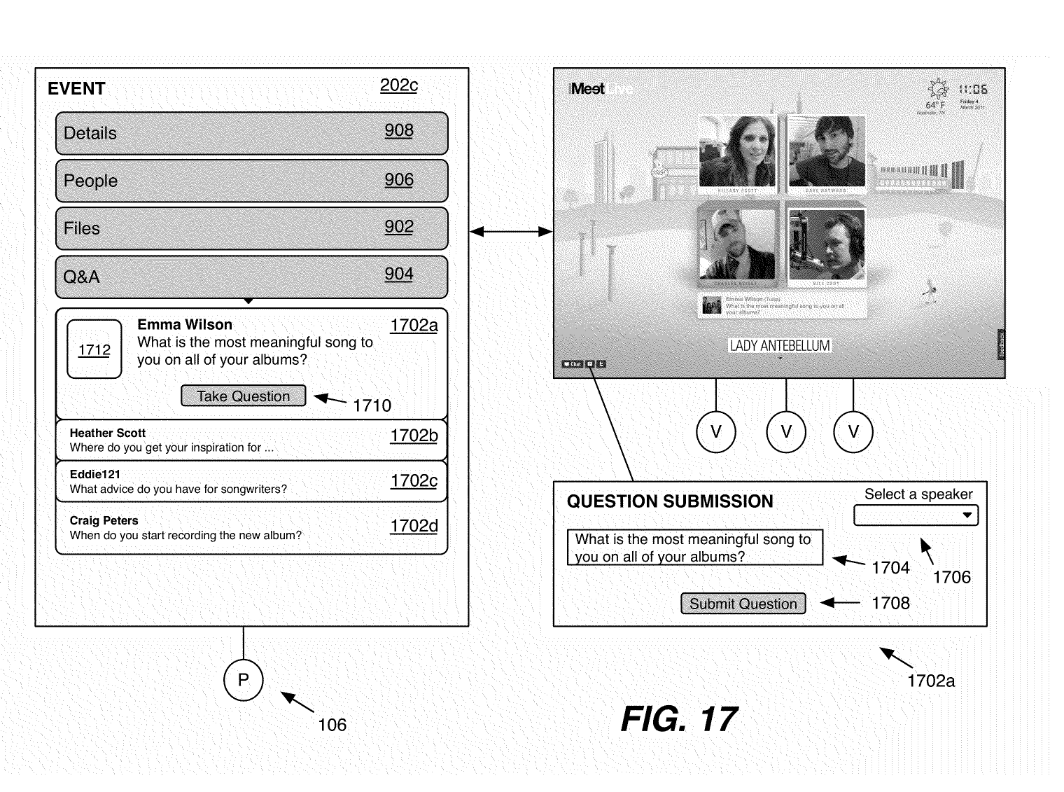

FIGS. 17-19 illustrate an embodiment of a question submission/management control implemented via the event production user interface 120 and the viewer user interface 124. In operation, the viewers 110 may launch a question submission panel 1702 by selecting the question submission component 1110. As illustrated in FIG. 17, viewers 110 may insert a question into a text box 1704, select a target speaker 108 for the question (drop-down box 1706), and submit the question to the conferencing system 102 (button 1708). Submitted questions may be displayed in the event production user interface 120 under the Q&A bar 904. The questions may be displayed as a scrollable feed. The event producer 106 may navigate the feed and select a particular question (question 1702a in FIG. 17). When selected, the question may be expanded to display the identity of the viewer (thumbnail 1712), the text of the question, and prompt the event producer 106 to “take the question” (button 1710). If the event producer 106 “takes” the question by selecting button 1710, the question 1702a is then presented in the online event 111 by displaying in the viewer user interface 124.

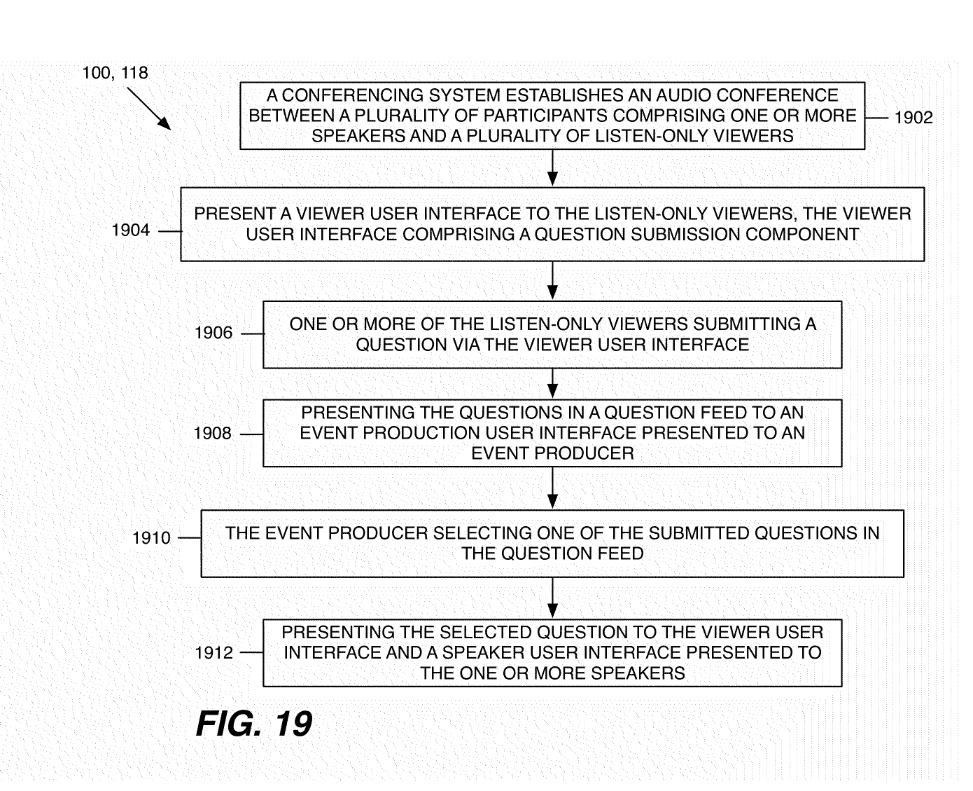

FIG. 19 illustrates the architecture, operation, and/or functionality of an embodiment of the event management/production modules 118 for implementing the question submission/management control. At block 1902, the conferencing system 102 establishes an audio conference 112 between one or more speakers 108, the event producer 106, and a plurality of viewers 110 accessing the conferencing system 102 via computing devices 104 connected to network(s) 106. At block 1904, the conferencing system 102 and/or servers 114 present the view user interface 124 to the viewers 110. At block 1906, one or more viewers 110 submit questions via the viewer user interface 124. At block 1908, the submitted questions are presented in the event production user interface 120 to the event producer 106. At block 1910, the event producer 106 may browse and select one of the submitted questions for presentation in the viewer user interface 124 (block 1912).

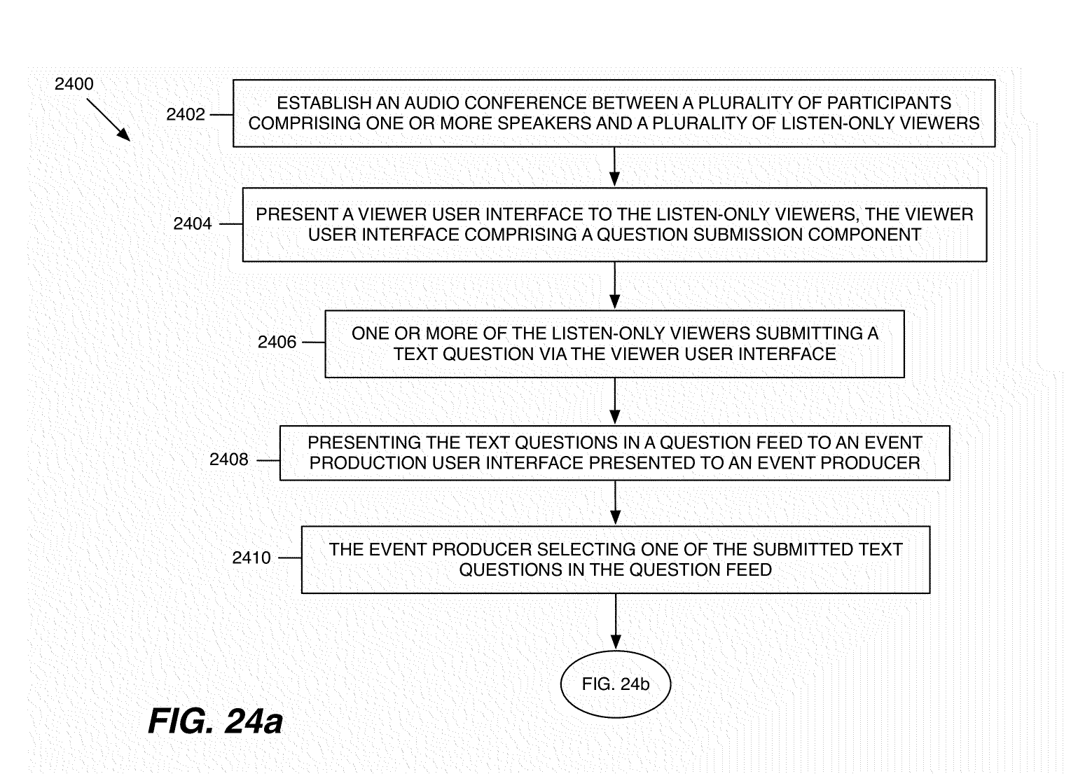

Another embodiment for implementing a question submission/management control in the system 100 will be described with reference to FIGS. 24-35. In general, the alternative embodiment may selectively employ different communication channels for the question submission and the question presentation processes. Viewers 110 may submit questions, in the manner described above, via a question submission panel 1702 (FIG. 17) presented in the viewer user interface 124. For example, a viewer 110 may insert a question for one or more of the speakers 110 into the text box 1704, and submit the question to the event producer 106. The text-based questions may be displayed in the Q&A feed 904 and selected for presentation during the online event 111. As described below in more detail, the event producer 106 and/or the submitting viewer 110 may selectively control whether the selected question is presented during the online event 111 as: (1) a text question (e.g., 1702a—FIG. 17); or (2) by the submitting viewer 110 via a live two-way audio connection associated with the audio conference 112.

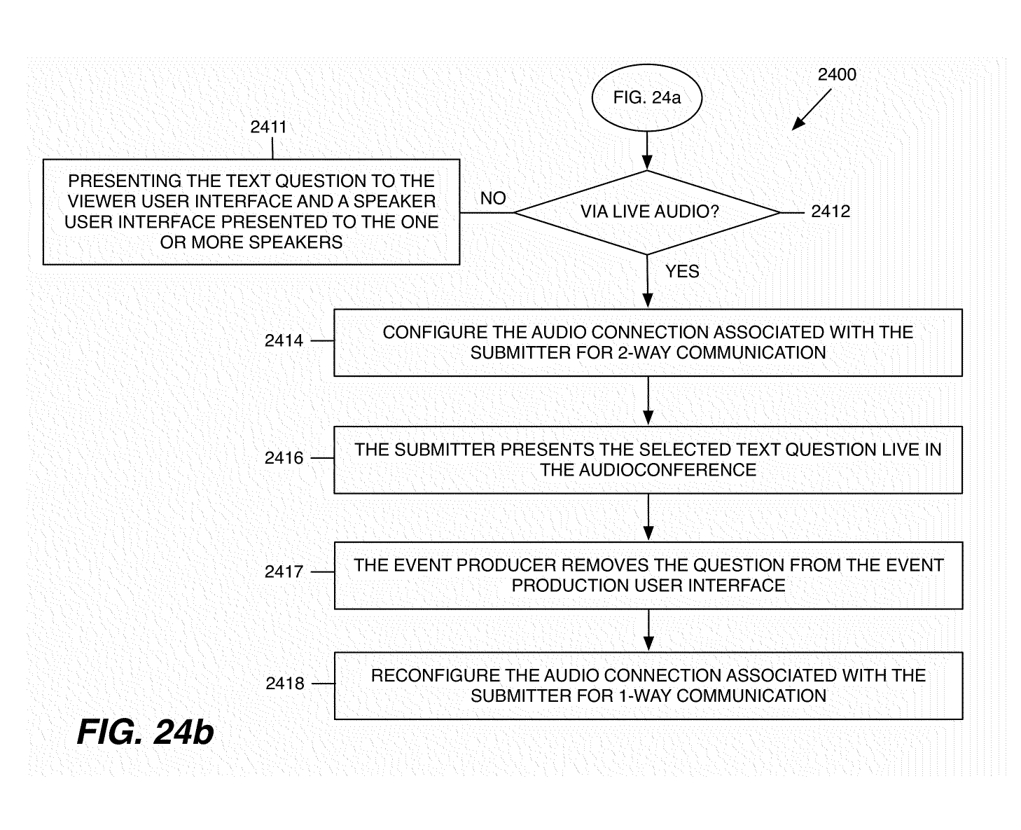

FIGS. 24a & 24b illustrate an embodiment of a method 2400 for implementing the selective text/audio question submission and control. At block 2402, the conferencing system 102 establishes an audio conference 112 between one or more speakers 108, the event producer 106, and a plurality of listen-only viewers 110 accessing the conferencing system 102 via computing devices 104 connected to network(s) 106. At block 2404, the event management/production module(s) 118 present a viewer user interface 124 to the listen-only viewers 110. As illustrated in FIG. 25, the viewer user interface 124 may comprise a question submission component 2502. A text question may be entered into a text box 2504. The text question may be limited to a predetermined number of characters. The question submission component 2502 may include a check box 2506 for indicating a desire to ask a question via live audio. If checked, the text question may be flagged for live presentation, by the submitting viewer, via the audio conference 112. If unchecked and selected by the event producer 106, the text question may be displayed in the manner described above.

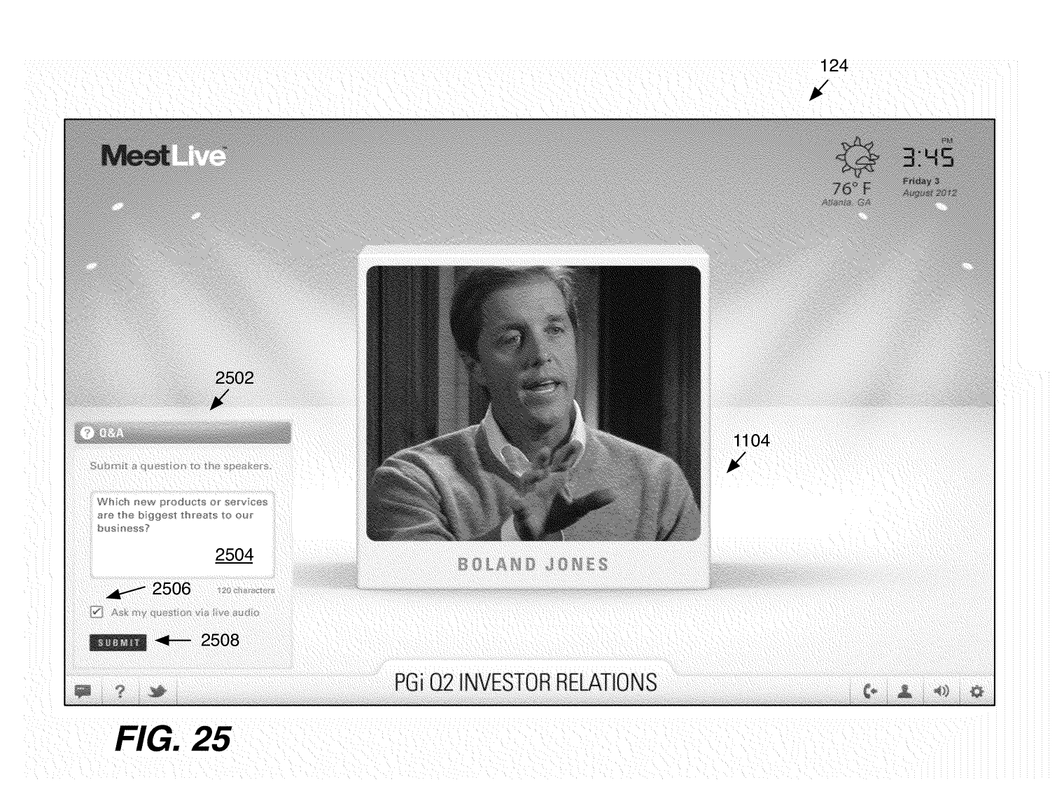

Referring again to FIG. 24, at block 2406, one or more of the listen-only viewers 110 may submit a text question via the viewer user interface 124 (e.g., by selecting submit button 2508—FIG. 25). At block 2408, submitted text questions may be presented in a questions feed (e.g., Q&A bar 904) to the event producer 106. In the embodiment illustrated in FIG. 26, the Q&A bar 904 may be selectively expanded and collapsed in a live feed panel 2602. The Q&A bar 904 displays each text question as a separate list item 1702 with, for example, the viewer's name and a profile picture. When the event producer 106 selects a list item 1702 (block 2408—FIG. 24), the list item 1702 may be modified to display controls for taking the question “via text” (button 2604) or “via audio” (button 2606). By default, the buttons 2604 and 2606 may be configured to visually display the viewer's preference (as indicated by check box 2506—FIG. 25).

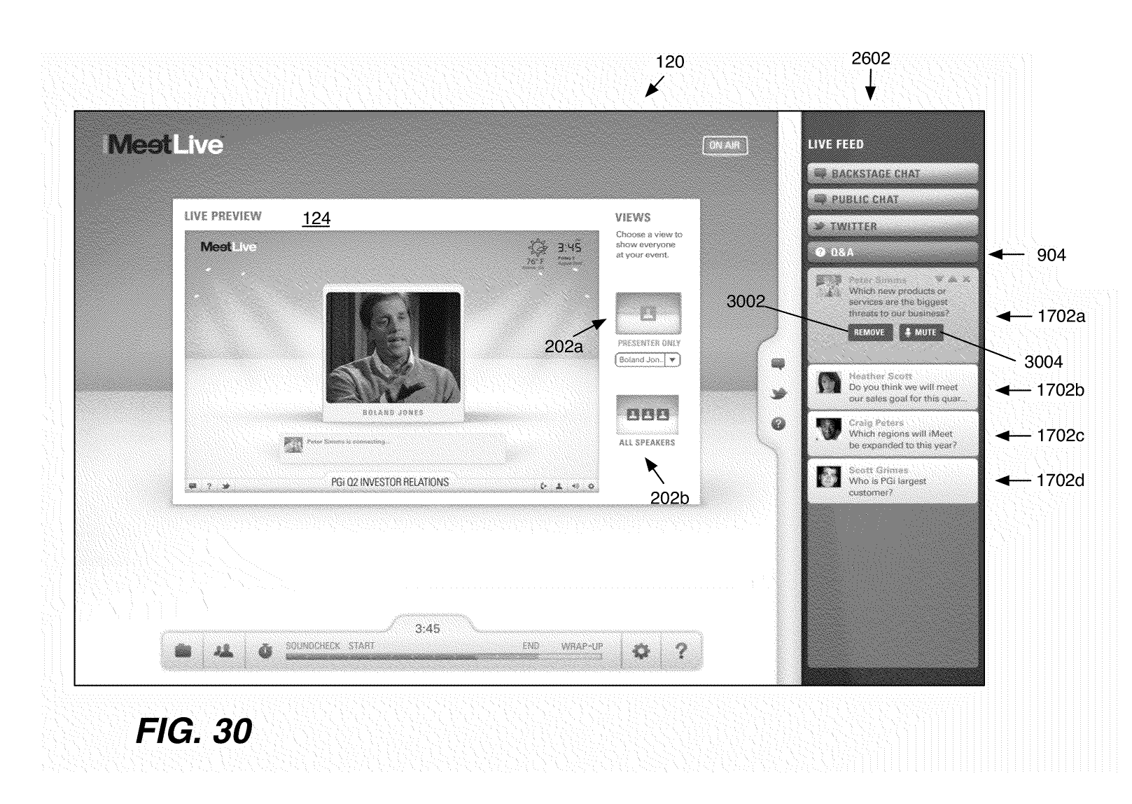

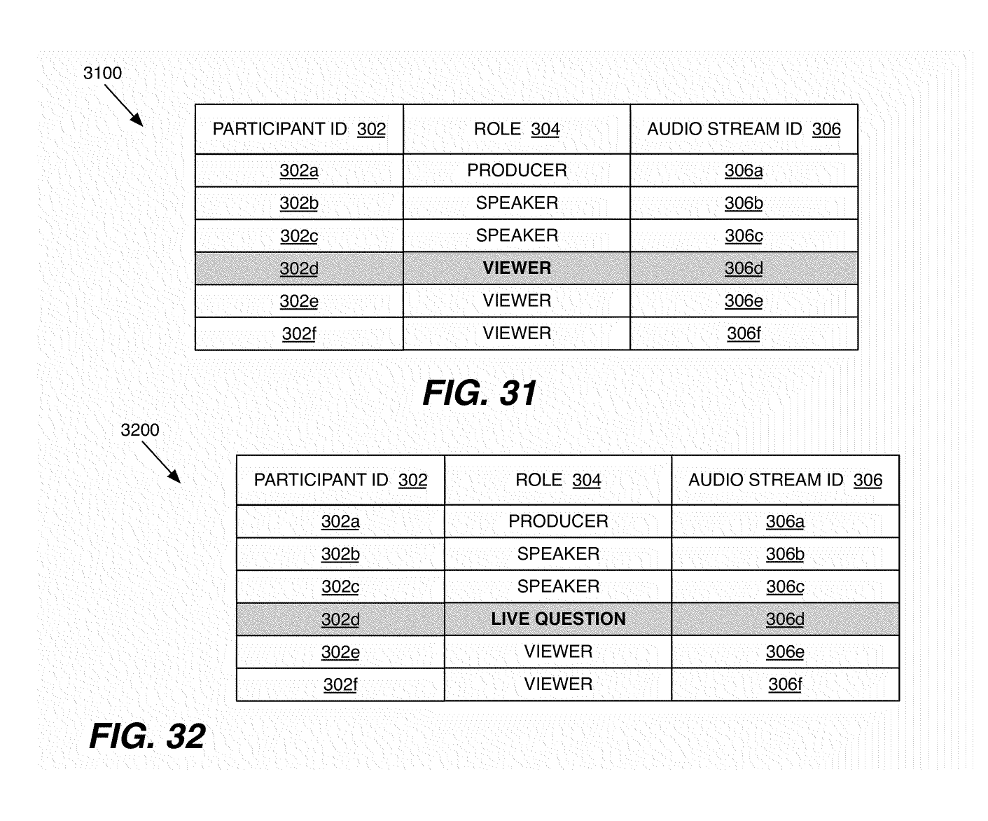

Referring to FIG. 24b, at decision block 2412, the event management/production module(s) 118 determine the appropriate means for presenting the selected question (i.e., via audio or via text). If via text, process flow proceeds to block 2411. If via audio, at block 2414, the conferencing system configures the audio connection associated with the submitting viewer 110 for two-way communications. It should be appreciated that the listen-only connection may be configured for two-way communication in various ways. In one embodiment, the listen-only connection may be established by “muting” a two-way connection. Two-way communication may be selectively controlled, for live presentation of selected questions, by “unmuting” the two-way connection. In other embodiments, as described above with reference to FIG. 3, the audio connections associated with the listen-only viewers 110 may be defined according to a viewer role, whereas the audio connections associated with the speakers 108 may be defined according to a speaker role. In this regard, two-way communication may be selectively controlled by modifying the role 304 from “viewer” (FIG. 31) to “speaker” or “live question” (FIG. 32) while the submitter presents the selected text question live in the audio conference 112 (block 2416—FIG. 24b). In other embodiments, a new audio stream 306d may be established. The event management/production module(s) 118 may interface with the audio conference 112 and the computing device(s) 104 (e.g., a mobile phone, landline phone, softphone, VoIP, etc.) to temporarily establish the two-way communication with the submitting viewer.

In another embodiment, the conferencing system may control the transition using two separate communication channels. For example, at the beginning of the online event 111, viewers may be connected to the audio conference 112 via a listen-only channel (e.g., using VoIP). When their question is taken via audio, the listen-only channel may be “muted” and a separate two-way communication channel may be established (e.g., again using VoIP). Referring again to FIG. 24b, at block 2417, the event producer may remove the question. In response to the question being removed, the two-way communication channel may be disconnected and the listen-only channel “unmuted”. In other embodiments, the audio connection may be reconfigured for one-way or listen-only communication after the live question is completed.

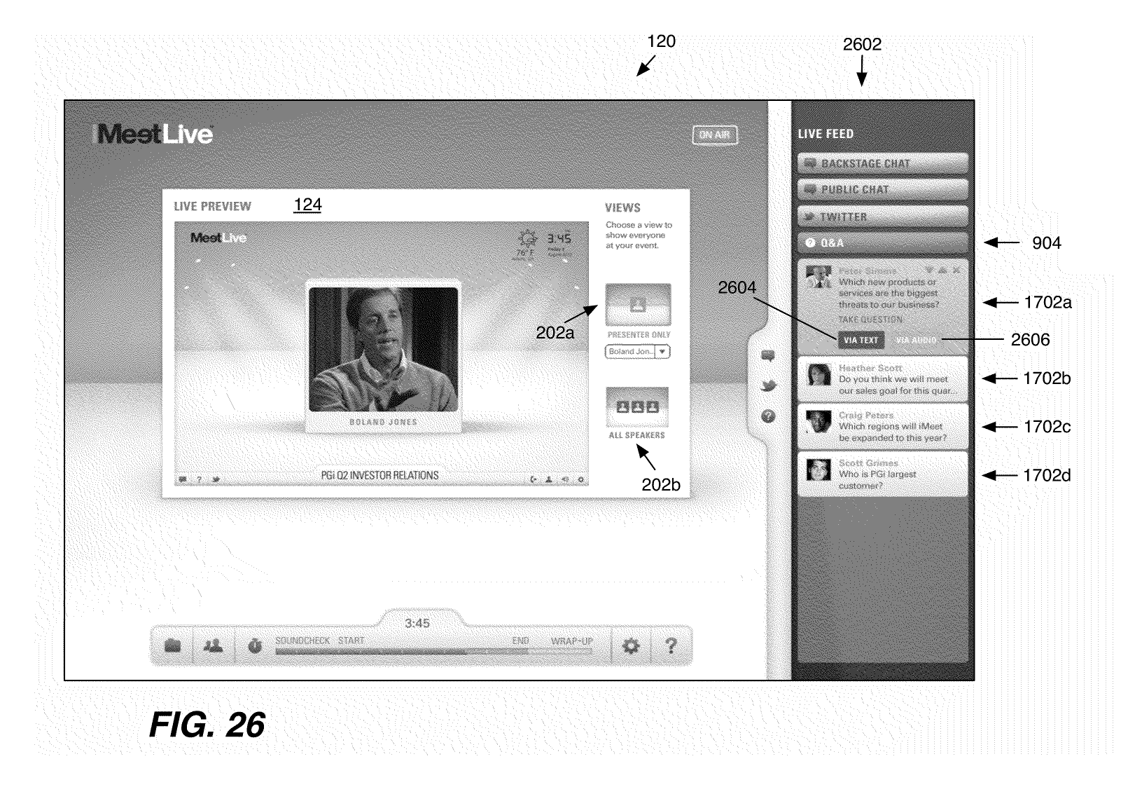

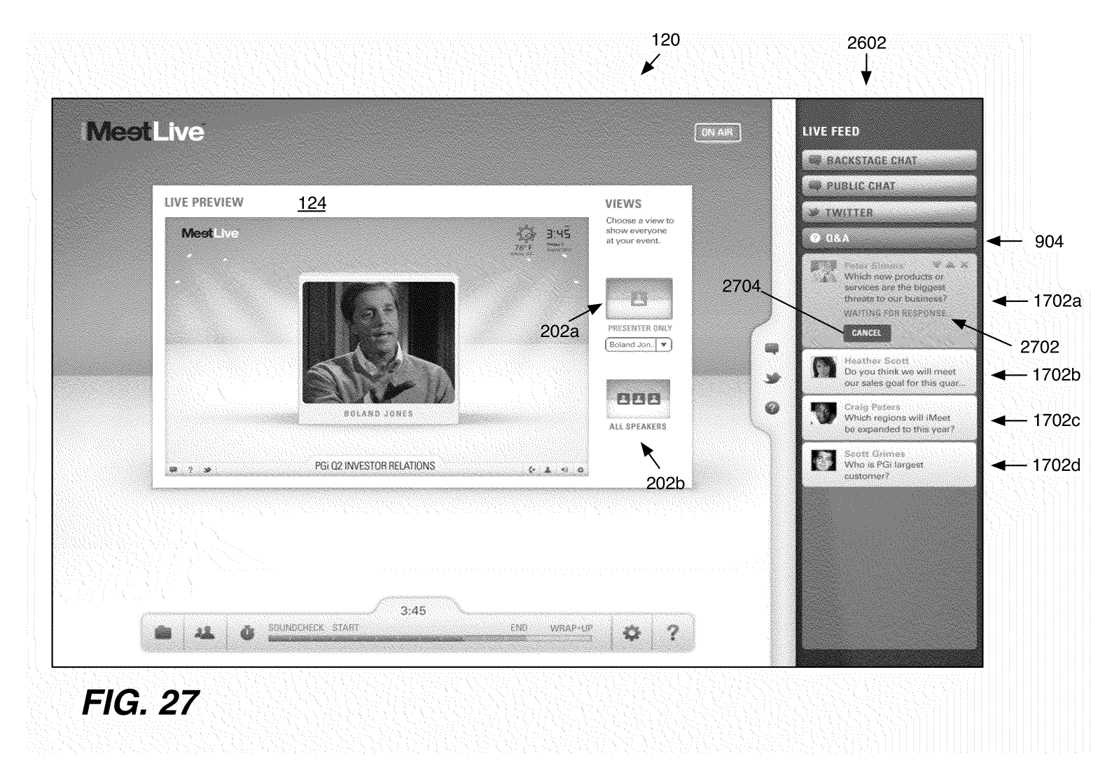

As mentioned above, the event producer 106 and/or the viewer 110 may control whether a question is presented via text or via live audio. In the embodiment illustrated in FIG. 27, the event producer 106 has selected the via audio button 2606 (FIG. 26). In response, the event management/production module 118 may send a provisioning request to the submitting viewer. The viewer user interface 124 displayed to the submitting viewer may display a notification 2802 (FIG. 28) The notification 2802 may comprise a message stating that the speaker is about to take the viewer's question via live audio. The notification 2802 may prompt the submitting viewer to connect their audio. If the yes button 2806 is selected, their computing device 104 may be configured for live audio. The submitting viewer may also decide not to present via live audio by selecting the no button 2804, in which case the question may be presented via text instead.

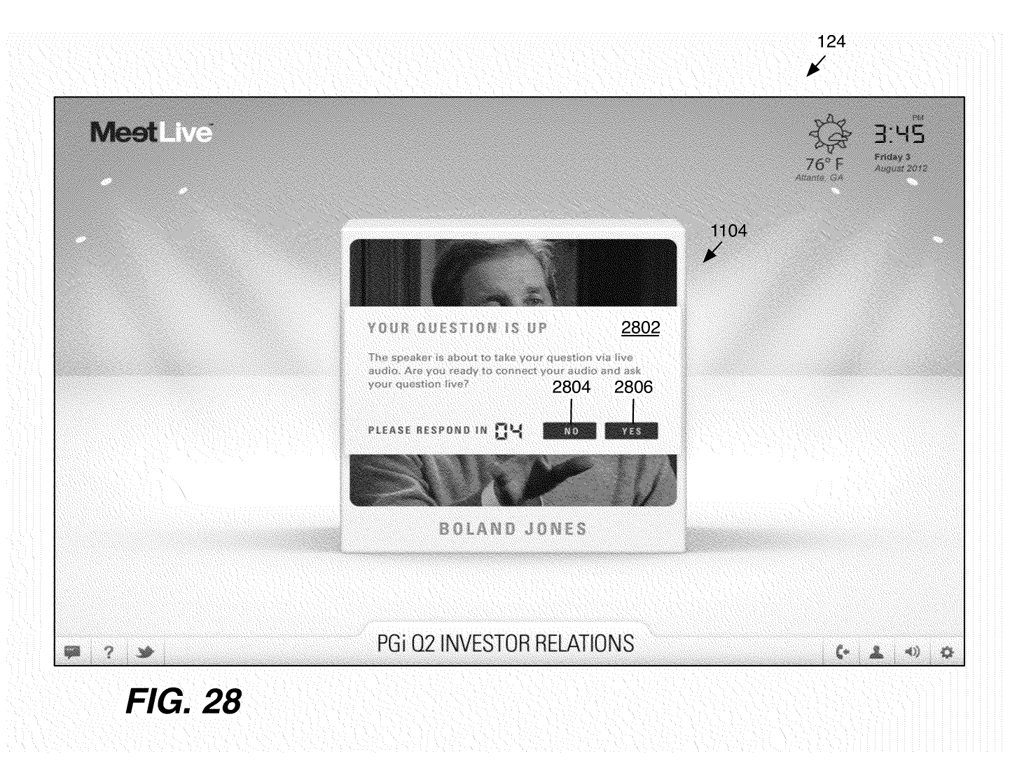

While the audio provisioning is in process, the event production user interface 120 may display a “waiting for response” message in the list item 1702a (FIG. 27). The speaker user interface 122 and the viewer user interface 124 present to the other viewers 110 may display a message 2902 (FIG. 29) indicating that the question submitter is currently provisioning their audio connection.

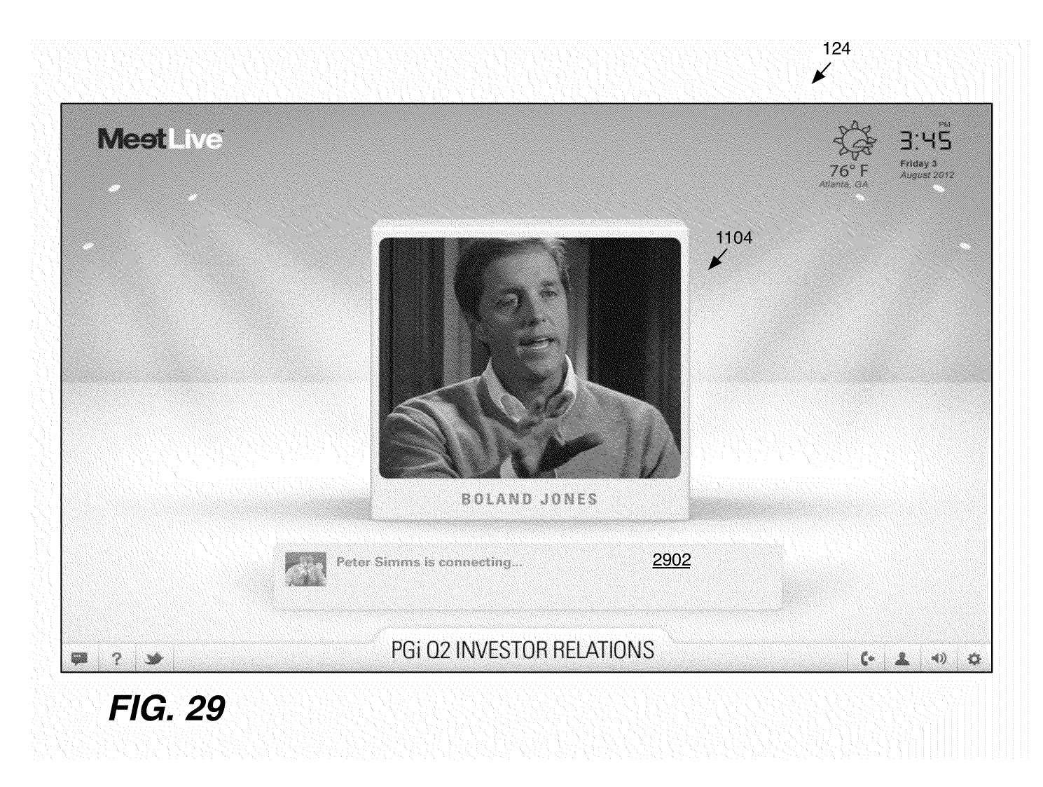

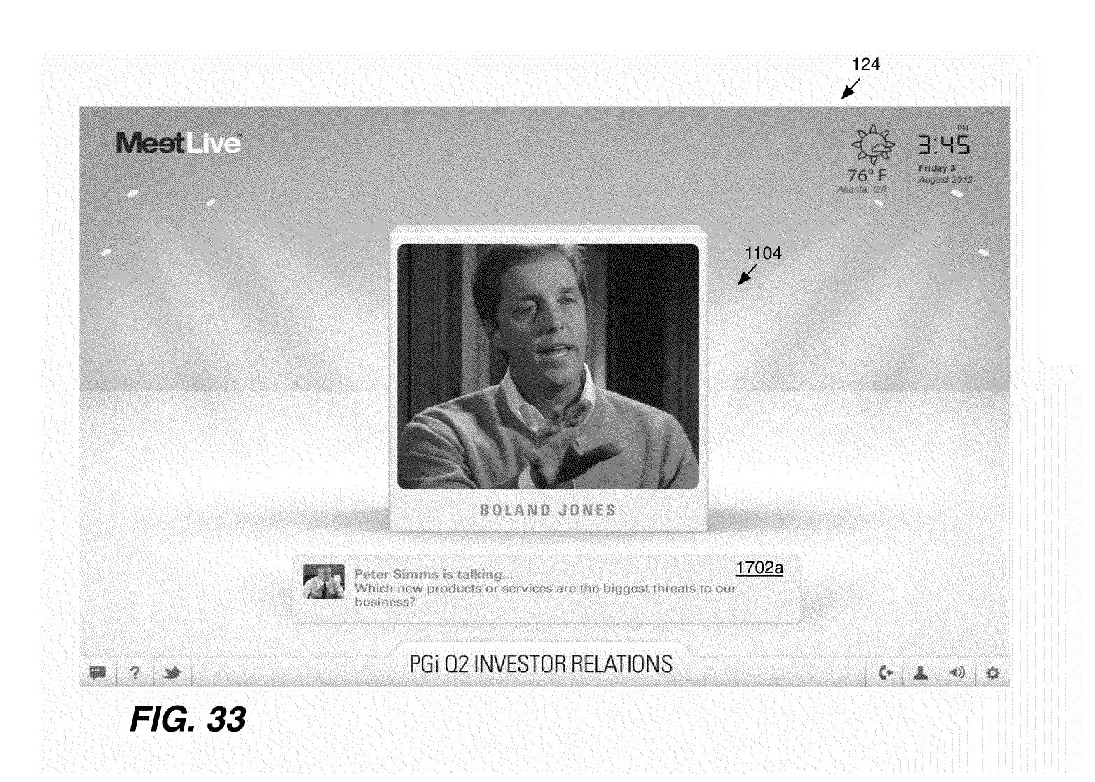

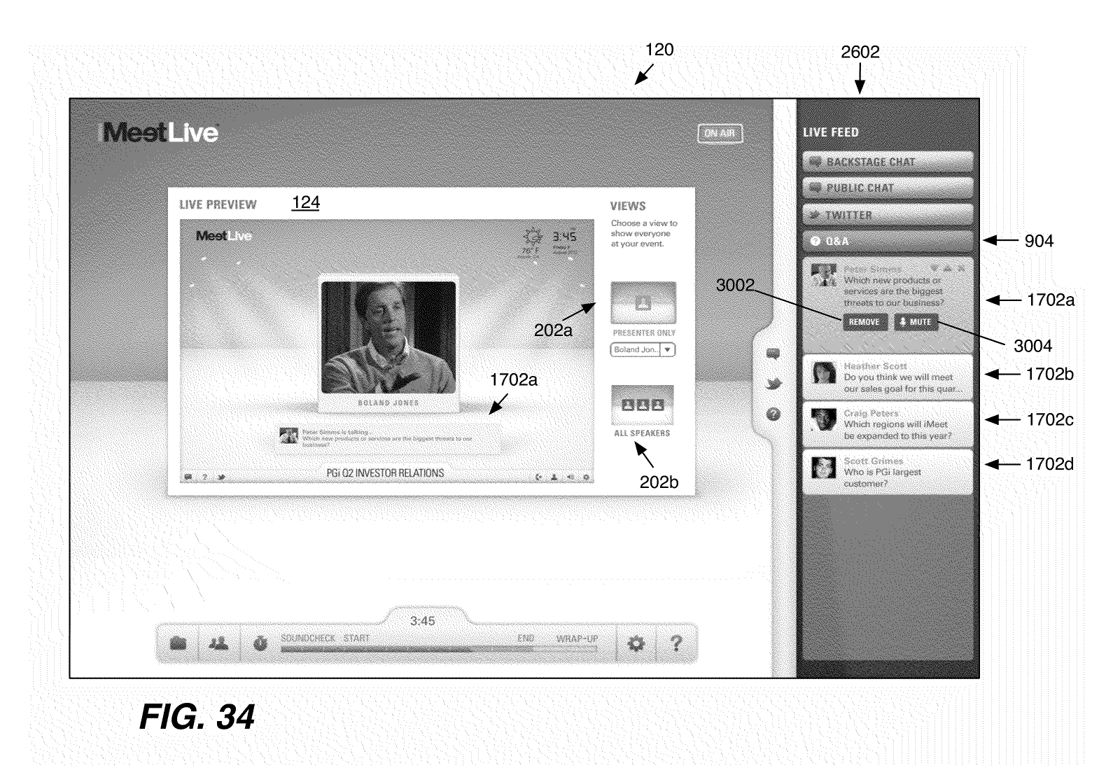

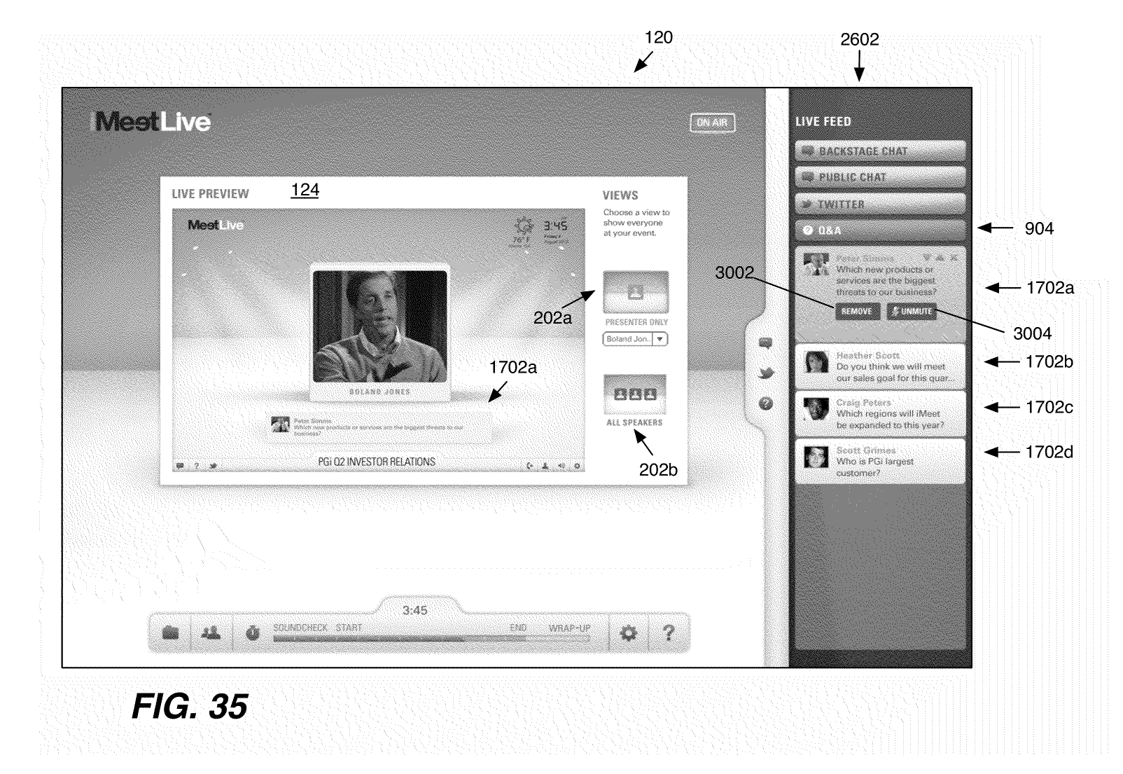

As illustrated in FIG. 30, after the audio provisioning is complete, the list item 1702a displayed in the event production user interface 120 may be updated with additional controls, such as, for example, a mute button 3004 and a remove button 3002. Furthermore, the speaker user interface 122, the event production user interface 120 (FIG. 34), and the viewer user interface 124 (FIG. 33) may be updated to display the text question 1702 and an indication that the submitting viewer is speaking FIG. 35 illustrates the event production user interface 120 after the event producer 106 has pressed the mute button 3004 to mute the submitting viewer. After the live question has been completed, the event producer may remove the question via button 3002.

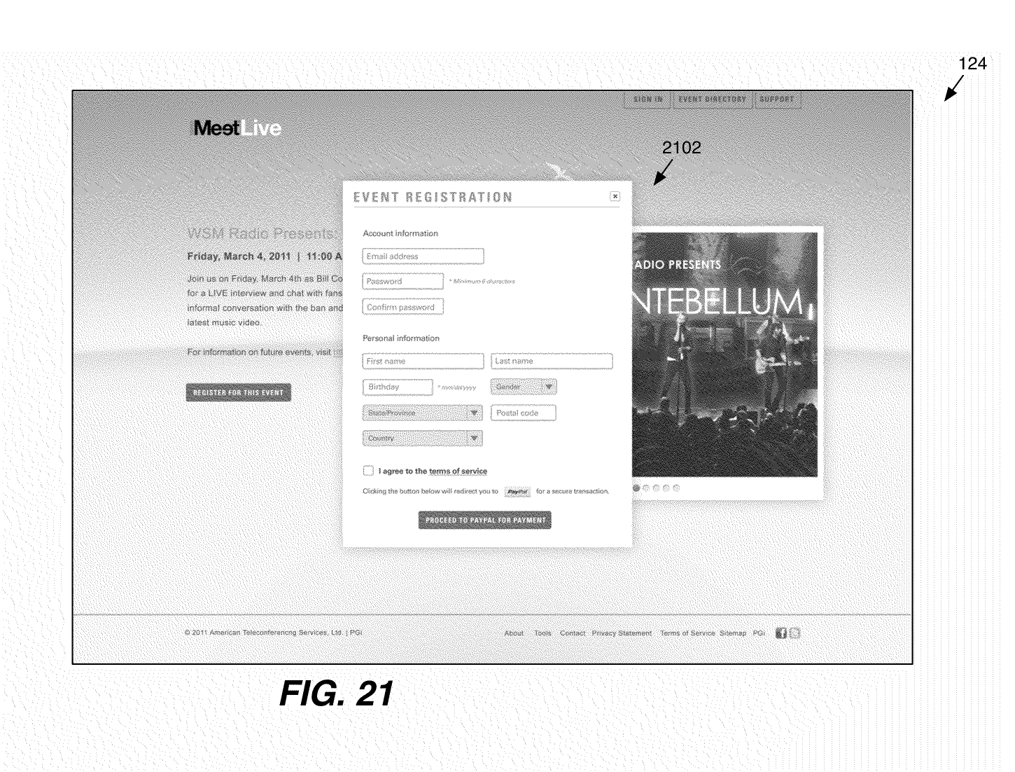

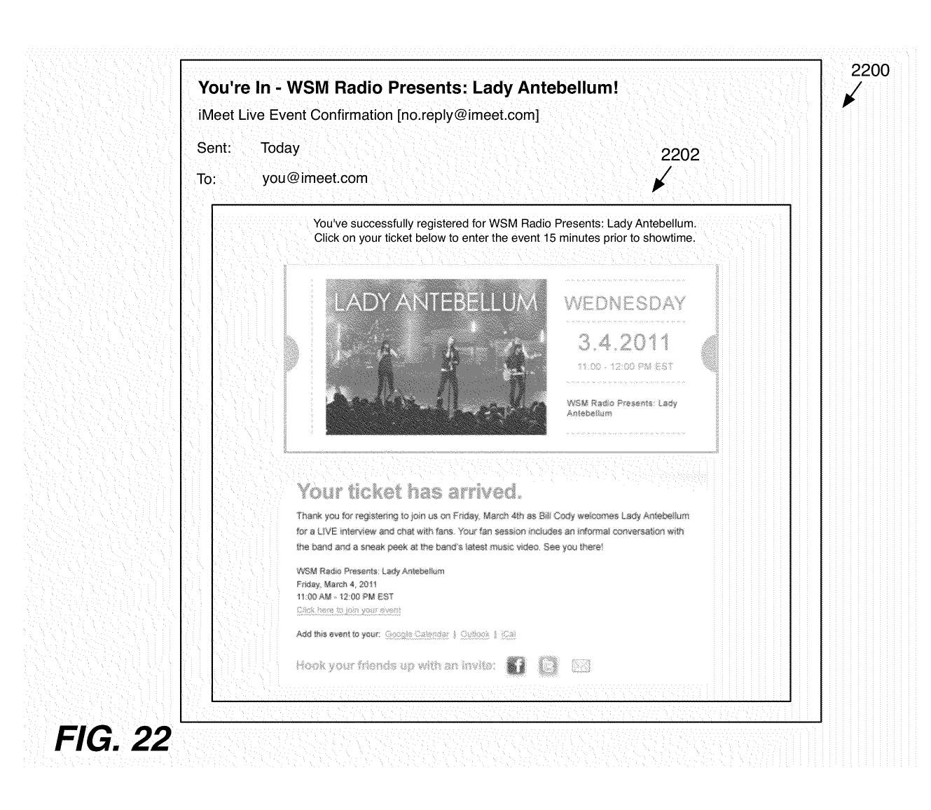

FIG. 21 illustrates an embodiment of the viewer user interface 124 for enabling viewers 110 to register for an online event 111. The event producer 106 may promote the online event 111 through social networking channels or by other means (e.g., email, SMS, etc.). The message may include a link to an event registration page associated with the viewer user interface 124. The event registration page may include promotional information about the online event, date/time, and an event registration panel 2102 prompting the viewer 110 to specify account information, personal information, and payment information (if the event has a fee) for registering for the event. After registering for the online event 111, a confirmation email or other message 2200 (FIG. 22) may be sent to the viewer 110. The confirmation message 2200 may include additional information 2202 to promote the online event 111.

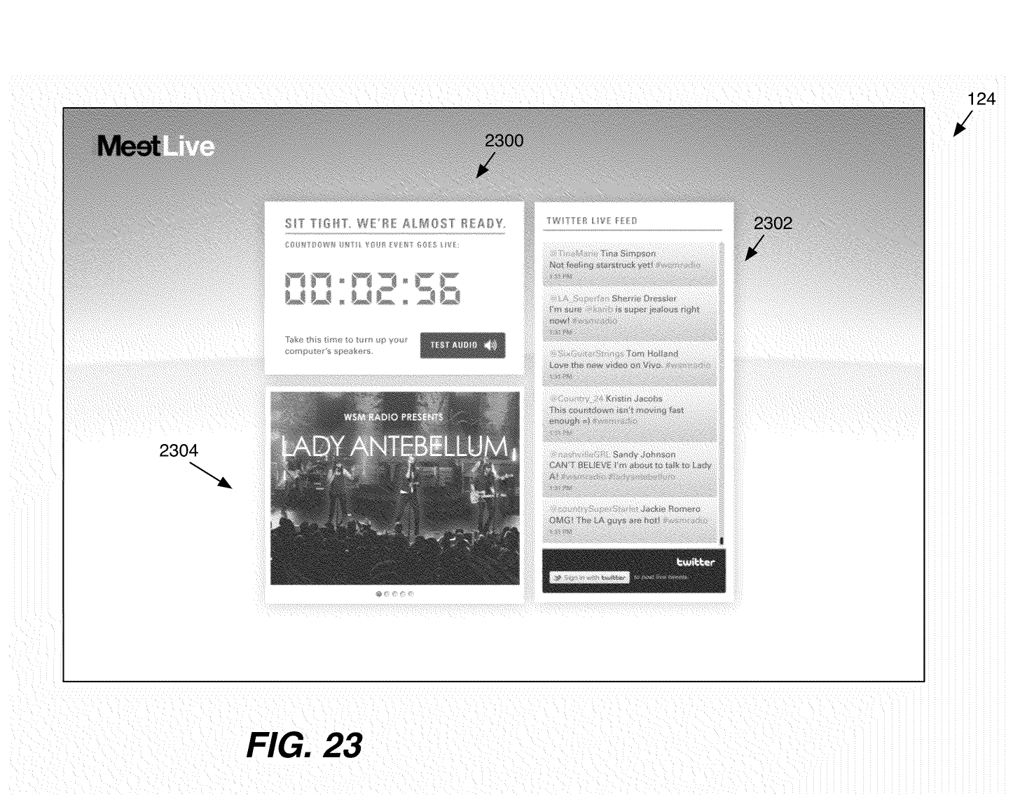

FIG. 23 illustrates an embodiment of a “waiting room” that may be displayed via the viewer user interface 124 if the viewer 110 joins the online event 111 prior to the scheduled start time. To enhance the user experience, the “waiting room” may include a social networking panel 2302 for enabling early attendees to interact and discuss the upcoming online event 111. The “waiting room” may include a countdown timer panel 2300 indicating when the online event 111 goes live. A further panel 2304 may present additional promotional information (e.g., introductory or teaser videos or any other information).

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the computer system 100. Furthermore, the logical functions may be embodied in any computer readable medium for use by or in connection with an instruction execution system, apparatus, or device, such as a computer-based system, processor-containing system, or other system associated with the computer system 100 that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for managing question submissions in an online event produced by an event producer, the method comprising:
a conferencing system establishing an audio conference between one or more speakers and a plurality of listen-only viewers;
presenting an event production user interface to an event producer and a viewer user interface to the listen-only viewers, the event production user interface configured to enable the event producer to control the viewer user interface during the online event;
receiving, via the viewer user interface, a text question submitted by one of the listen-only viewers for presentation to one or more speakers; and
the event producer selecting the text question, via the event production user interface, for live audio presentation by the listen-only viewer via the audio conference.

2. The method of claim 1, wherein the live audio presentation of the selected text question comprises configuring an audio connection associated with the listen-only viewer for two-way communication.

3. The method of claim 2, wherein the configuring the audio connection for two-way communication involves changing a participant role.

4. The method of claim 3, wherein the participant role is changed from a viewer role to one of a speaker role and a live question role.

5. The method of claim 1, wherein the listen-only viewer requests to present the submitted text question for live audio presentation via the audio conference.

6. The method of claim 1, further comprising presenting the text question in the viewer user interface during the live audio presentation by the listen-only viewer.

7. The method of claim 1, wherein the text question is submitted via a question submission component presented via the viewer user interface.

8. The method of claim 1, wherein the text question is added to a questions feed presented in the event production user interface.

9. A computer program embodied in a computer readable medium and executable by a processor for managing question submissions in an online event produced by an event producer, the computer program comprising logic configured to:
establish an audio conference between one or more speakers and a plurality of listen-only viewers;
present an event production user interface to an event producer and a viewer user interface to the listen-only viewers, the event production user interface configured to enable the event producer to control the viewer user interface during the online event;
receive, via the viewer user interface, a text question submitted by one of the listen-only viewers for presentation to one or more speakers; and
select the text question, via the event production user interface, for live audio presentation by the listen-only viewer via the audio conference.

10. The computer program of claim 9, wherein the live audio presentation of the selected text question comprises configuring an audio connection associated with the listen-only viewer for two-way communication.

11. The computer program of claim 10, wherein the configuring the audio connection for two-way communication involves changing a participant role.

12. The computer program of claim 11, wherein the participant role is changed from a viewer role to one of a speaker role and a live question role.

13. The computer program of claim 9, wherein the listen-only viewer requests to present the submitted text question for live audio presentation via the audio conference.

14. The computer program of claim 9, further comprising logic configure to present the text question in the viewer user interface during the live audio presentation by the listen-only viewer.

15. The computer program of claim 9, wherein the text question is submitted via a question submission component presented via the viewer user interface.

16. The computer program of claim 9, wherein the text question is added to a questions feed presented in the event production user interface.

17. A computer system comprising:
a conferencing system for establishing an audio conference between a plurality of listen-only viewers, an event producer, and one or more speakers, each operating a corresponding computing device connected via a communication network;
a server configured to communicate with the conferencing system and the computing devices, the server comprising one or more processors and an event management/production module, which is stored in memory and executed by the processors, the event management/production module comprising:
logic configured to present an event production user interface to an event producer and a viewer user interface to the listen-only viewers, the event production user interface configured to enable the event producer to control the viewer user interface during the online event;
logic configured to receive, via the viewer user interface, a text question submitted by one of the listen-only viewers for presentation to one or more speakers; and
logic configured to display the text question in the event production user interface and receive a selection of the text question for live audio presentation by the listen-only viewer via the audio conference.

18. The computer system of claim 17, wherein the event management/production module further comprises logic configured to configure an audio connection associated with the listen-only viewer for two-way communication.

19. The computer system of claim 17, wherein the configuring the audio connection for two-way communication involves changing a participant role from a viewer role to one of a speaker role and a live question role.

20. The computer system of claim 17, wherein the listen-only viewer requests to present the submitted text question for live audio presentation via the audio conference.
